(19) United States
(12) Patent Application Publication
(10) Pub. No.: US 2026/0100112 A1
(43) Pub. Date: Apr. 9, 2026

(54) ELECTRONIC GAMING SYSTEMS INCLUDING METAMORPHIC GAME ENHANCEMENTS AND SELECTABLE BONUS GAMES

(71) Applicant: Aristocrat Technologies, Inc., Las Vegas, NV (US)

(72) Inventor: John Ludwick, Reno, NV (US)

(21) Appl. No.: 19/056,314

(22) Filed: Feb. 18, 2025

Related U.S. Application Data
(60) Provisional application No. 63/703,358, filed on Oct. 4, 2024.

(51) Int. Cl. G07F 17/34; G07F 17/32

(52) U.S. Cl. CPC G07F 17/34; G07F 17/3267

(57) ABSTRACT

An electronic gaming system includes a memory for storing instructions, and a game controller in communication with the memory. The game controller includes a processor(s), where when the instructions are executed by the processor(s), the processor(s) is configured to display on a display device a base reel game including a plurality of reels. The plurality of reels includes graphic game symbols, and/or metamorphic enhancement feature symbols, and the plurality of reels are defined by a base game reels table. The processor(s) is also configured to determine that a base reel game outcome triggers a plurality of metamorphic enhancement features associated with the metamorphic enhancement feature symbols. The base reel game outcome is determined using a base reel game outcome table. Additionally, the processor(s) is configured to display a free spin bonus game including a plurality of bonus game reels defined by a bonus game reels table.

### CROSS REFERENCE TO RELATED APPLICATIONS

This application claims the benefit of priority to U.S. Provisional Ser. No. 63/703,358 , filed Oct. 4, 2024, the content of which is hereby incorporated herein by reference in its entirety.

### TECHNICAL FIELD

The field of disclosure relates generally to electronic gaming, and more specifically, to electronic gaming systems including metamorphic game enhancements and selectable bonus games associated with the metamorphic game enhancements.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency, or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Notably, some games may include an element of skill on the part of the player and are therefore not entirely random.

### BRIEF DESCRIPTION

In one aspect, an electronic gaming system includes at least one memory for storing instructions; and a game controller in communication with the at least one memory, the game controller including at least one processor, wherein when the instructions are executed by the at least one processor, the at least one processor is configured to: cause to be displayed on a display device a base reel game including a plurality of reels, the plurality of reels including at least one of graphic game symbols, or metamorphic enhancement feature symbols, wherein the plurality of reels are defined by a base game reels table; determine that a base reel game outcome triggers each metamorphic enhancement feature of a plurality of metamorphic enhancement features associated with the metamorphic enhancement feature symbols, the base reel game outcome determined using a base reel game outcome table; cause to be displayed on the display device two distinct, selectable bonus games, each of the two distinct, selectable bonus games associated with the triggered, plurality of metamorphic enhancement features, wherein the two distinct, selectable bonus games include (i) a free spin bonus game including a plurality of bonus game reels defined by a bonus game reels table and (ii) a hold-and-spin bonus game including a distinct plurality of bonus game reels defined by a distinct bonus game reels table; and in response to the free spin bonus game of the two distinct bonus games being selected, cause to be displayed on the display device the plurality of bonus game reels defined by the bonus game reels table for the selected free spin bonus game.

In another aspect, a method of electronic gaming implemented on an electronic gaming machine includes: causing to be displayed on a display device a base reel game including a plurality of reels, the plurality of reels including at least one of graphic game symbols, or metamorphic enhancement feature symbols, wherein the plurality of reels are defined by a base game reels table; determining that a base reel game outcome triggers each metamorphic enhancement feature of a plurality of metamorphic enhancement features associated with the metamorphic enhancement feature symbols, the base reel game outcome determined using a base reel game outcome table; causing to be displayed on the display device two distinct, selectable bonus games, each of the two distinct, selectable bonus games associated with the triggered, plurality of metamorphic enhancement features, wherein the two distinct, selectable bonus games include (i) a free spin bonus game including a plurality of bonus game reels defined by a bonus game reels table and (ii) a hold-and-spin bonus game including a distinct plurality of bonus game reels defined by a distinct bonus game reels table; and in response to the free spin bonus game of the two distinct bonus games being selected, causing to be displayed on the display device the plurality of bonus game reels defined by the bonus game reels table for the selected free spin bonus game.

In an additional aspect, a non-transitory computer-readable storage medium with instructions stored thereon is provided. The instructions, in response to execution by at least one processor, cause the at least one processor to: cause to be displayed on a display device a base reel game including a plurality of reels, the plurality of reels including at least one of graphic game symbols, or metamorphic enhancement feature symbols, wherein the plurality of reels are defined by a base game reels table; determine that a base reel game outcome triggers each metamorphic enhancement feature of a plurality of metamorphic enhancement features associated with the metamorphic enhancement feature symbols, the base reel game outcome determined using a base reel game outcome table; cause to be displayed on the display device two distinct, selectable bonus games, each of the two distinct, selectable bonus games associated with the triggered, plurality of metamorphic enhancement features, wherein the two distinct, selectable bonus games include (i) a free spin bonus game including a plurality of bonus game reels defined by a bonus game reels table and (ii) a hold-and-spin bonus game including a distinct plurality of bonus game reels defined by a distinct bonus game reels table; and in response to the free spin bonus game of the two distinct bonus games being selected, cause to be displayed on the display device the plurality of bonus game reels defined by the bonus game reels table for the selected free spin bonus game.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIGS. 4A-4C are example user interfaces or screenshots of a sequence of a base reel game for an example electronic game in accordance with the present disclosure.

FIG. 5A is an example user interface or screenshot of the base reel game for an example electronic game after triggering a power feature associated with a metamorphic, in accordance with the present disclosure.

FIG. 5B is an example user interface or screenshot of the base reel game displaying a bonus game pick screen associated with the power feature of FIG. 5A, in accordance with the present disclosure.

FIG. 5C is an example user interface or screenshot of a power feature free spin bonus game associated with the power feature of FIG. 5A, in accordance with the present disclosure.

FIGS. 5D-5F are example user interfaces or screenshots of a sequence of a power feature hold-and-spin bonus game associated with the power feature of FIG. 5A, in accordance with the present disclosure.

FIG. 6A is an example user interface or screenshot of the base reel game displaying a bonus game pick screen associated with a double feature associated with a metamorphic, in accordance with the present disclosure.

FIG. 6B is an example user interface or screenshot of a double feature free spin bonus game associated with the double feature of FIG. 6A, in accordance with the present disclosure.

FIGS. 6C and 6D are example user interfaces or screenshots of a sequence of a double feature hold-and-spin bonus game associated with the double feature of FIG. 6A, in accordance with the present disclosure.

FIG. 7A is an example user interface or screenshot of the base reel game displaying a bonus game pick screen associated with bounty feature associated with a metamorphic, in accordance with the present disclosure.

FIGS. 7B-7D are example user interfaces or screenshots of a sequence of a bounty feature free spin bonus game associated with the bounty feature of FIG. 7A, in accordance with the present disclosure.

FIGS. 7E-7H are example user interfaces or screenshots of a sequence of a bounty feature hold-and-spin bonus game associated with the bounty feature of FIG. 7A, in accordance with the present disclosure.

FIG. 8A is an example user interface or screenshot of a base reel game where a power feature and a bounty feature are triggered, in accordance with the present disclosure.

FIG. 8B is an example user interface or screenshot of free spin bonus game associated with the simultaneously triggered power feature and bounty feature of FIG. 8A, in accordance with the present disclosure.

FIGS. 9A and 9B are exemplary user interfaces or screenshots of wagering options for a base reel game for an example electronic game in accordance with the present disclosure.

### DETAILED DESCRIPTION

In some known electronic gaming systems, awards and/or outcomes of a primary game may present a game outcome as a reel game (e.g., a slot game) simulation. For example, an award value associated with a game outcome may be presented in the simulated reel game outcome as a symbol combination and/or one or more special symbols that correspond to the same award value. Additionally in some known games, the award value of the game outcome may desirably be partitioned or distributed across a base reel game outcome and one or more bonus game outcomes (e.g., outcomes of one or more free reel spins, wheel spins, or hold-and-spin). For example, an award value associated with one or more winning game patterns may be presented as being awarded in a base reel game outcome and one or more bonus game outcomes.

However, not all known electronic games include secondary bonus games due to the difficulty and complexity of increased mathematical computations and/or winning probability scenarios (e.g., pay tables). Moreover, the inclusion of multiple bonus games with a base reel game to partition game outcomes increases the memory requirements and/or processing demands on the gaming system. This is especially true where the base reel game and bonus games rely on similar components or gameplay features for each game (e.g., base reel game reels used in bonus reel games). In this example, the mathematical computations and/or winning probability scenarios need to account for a single gameplay feature being used across multiple games. Additionally, the internal controllers responsible for operating the game within the computing system must determine which gameplay scenario is currently being triggered and then make sure specific data relating to the shared gameplay feature is properly queried or pulled based on the triggered gameplay scenario. This in turn increases the processing power and/or processing need on internal controllers and computing systems operating the games including shared gameplay features. A need exists to address these limitations, while also improving on machine performance, memory storage and the overall functioning of the networked system controlling the gaming devices.

Embodiments of the present disclosure provide systems, program products, and methods for including a plurality of identifiable, single reel tables and single game outcome table, each associated with a base reel game, a bonus game, or any combination of bonus games. The single reel tables define characteristics and/or properties (e.g., reel stop positions, game symbols included therein) for distinct and specific reels used to play each of the base reel game, the bonus game, or the combination of bonus games. Additionally, the single game outcome tables utilize the corresponding single reel table for each individual base reel game, bonus game, and/or combination of bonus games to determine outcomes for each played game. The inclusion of the plurality of identifiable, single reel tables and single game outcome tables simplify the query and/or data pull process for the internal controller and/or computing system when playing the base reel game and/or triggered bonus game(s). Specifically, once the internal controller or computing system identifies which game is being played/triggered (e.g., single bonus game, combination bonus games), the internal controller need only query or pull the single reel table and single game outcome table associated with that game—no additional tables are shared between games, and therefore do not need to be pulled.

The inclusion of the single reel tables and single game outcome tables in the systems described herein, potentially increases the variability of the game, as well as improves control and assurance of RTP during the gameplay. Additionally, and to improve technical issues commonly experienced during gameplay, the inclusion of the single reel tables and single game outcome tables can also reduce the computational resources needed to operate the game and/or improve game processing speeds when compared to known electronic games.

The example systems, program products, and methods of the present disclosure represent a technical improvement in the field of electronic gaming. Technical improvements represented by the present disclosure include: (i) presenting Class II and Class III game outcomes as one or more outcomes of a bonus game added within a reel based game; (ii) utilizing multiple bonus games to provide additional gameplay features/winning opportunities in addition to the gameplay of a reel based game; (iii) increasing the flexibility and variability in presenting award values of a game outcome as one or more bonus game outcomes; (iv) displaying immediate bonus game feedback to a player; (v) reducing the computational resources needed as a result of simplifying gaming process by including single reel tables and single game outcome tables associated with each of the games played on the system; (vi) improving the computational or processing speed for playing the game as a result of simplifying gaming process by including single reel tables and single game outcome tables associated with each of the games played on the system; and/or (vii) improved control and assurance of RTP by enabling control of the credit awards through the bonus games triggered by a reel based game. Additional and/or alternative technical improvements may exist.

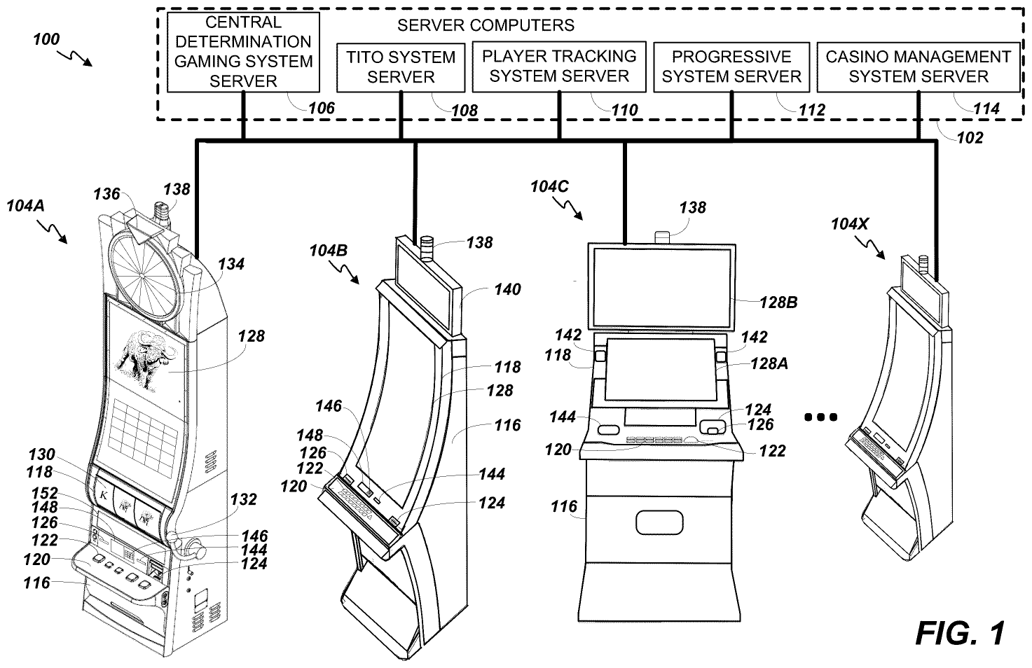

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

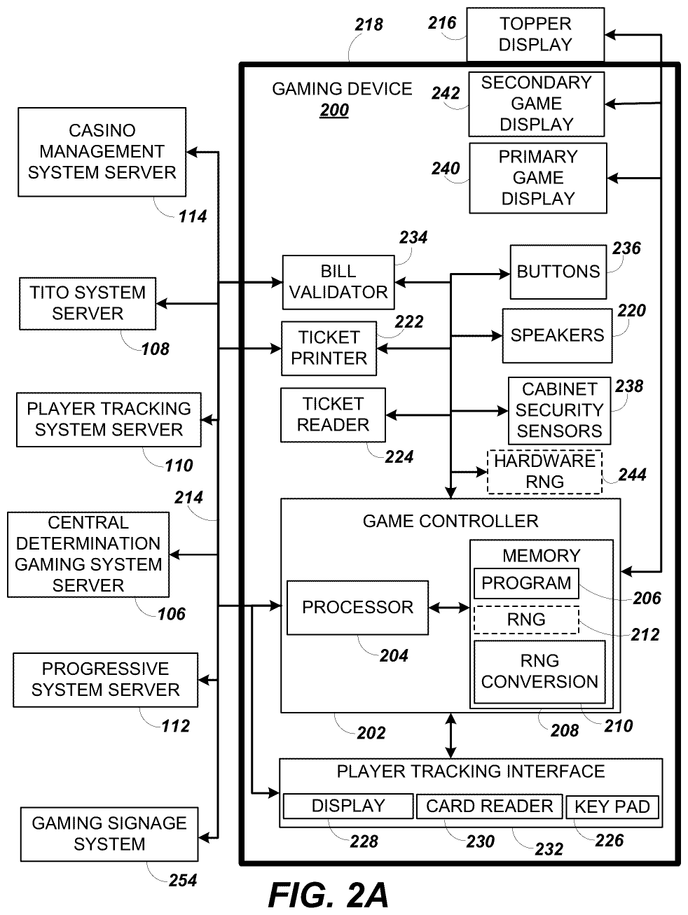

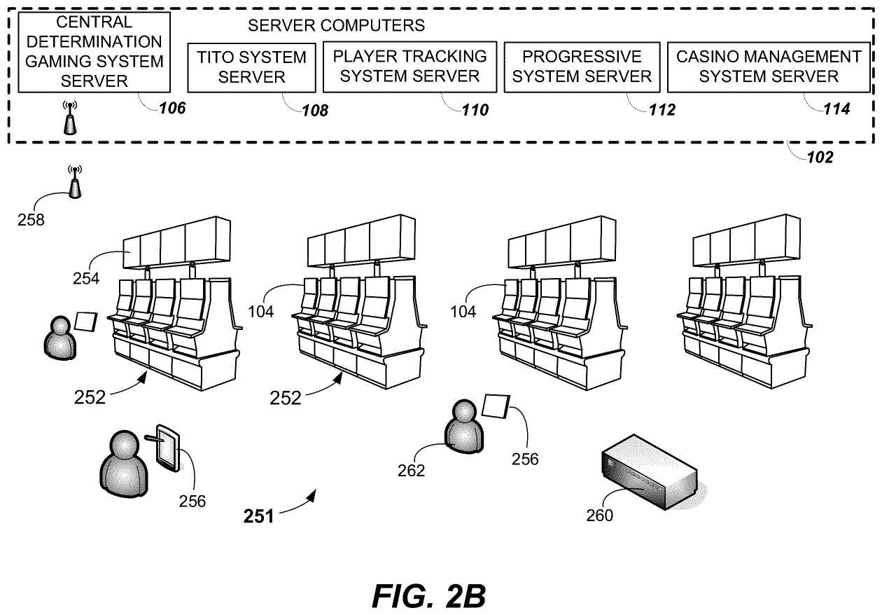

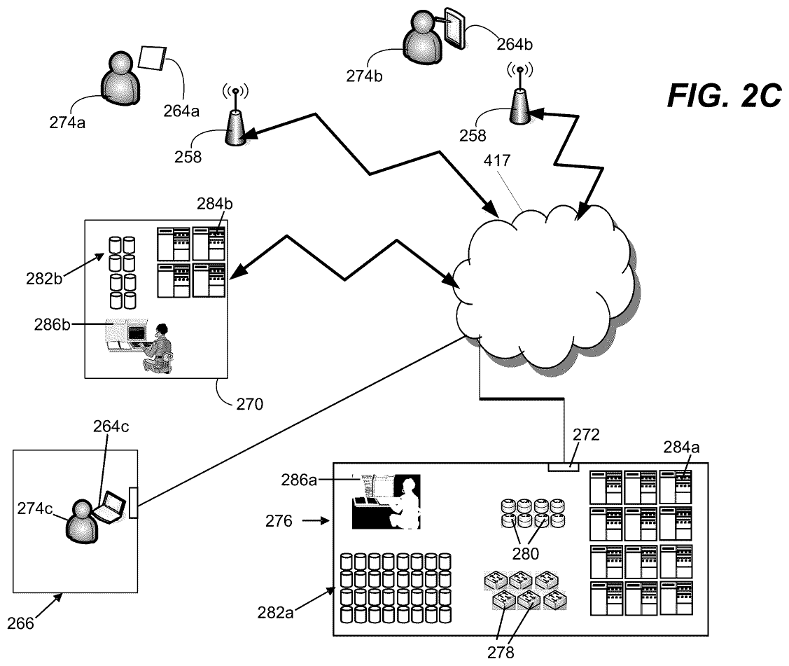

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play, or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game displays 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding number of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types, and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

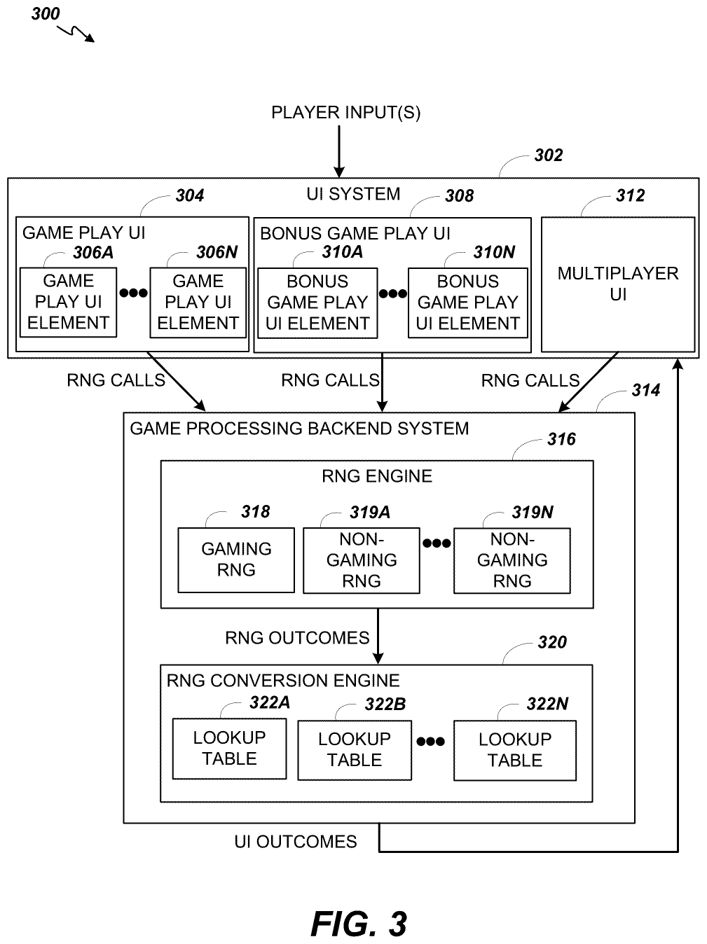

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

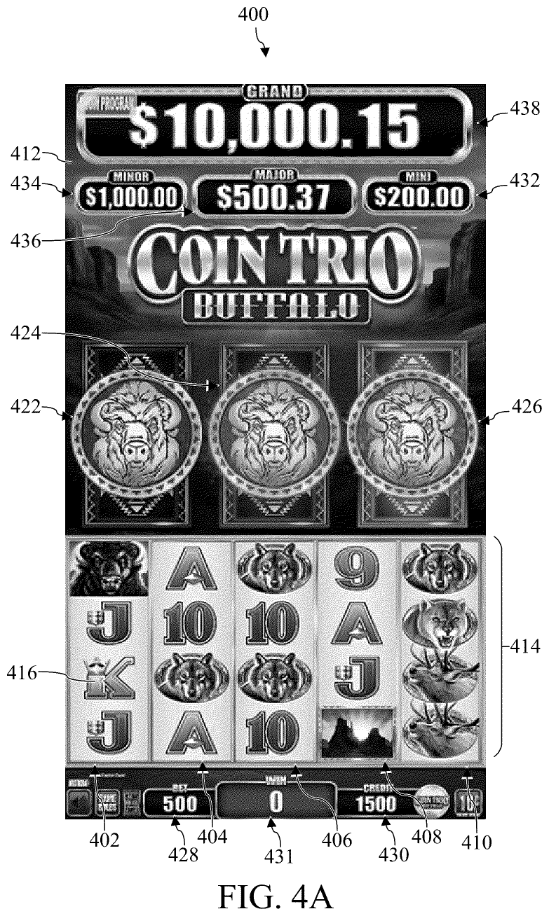

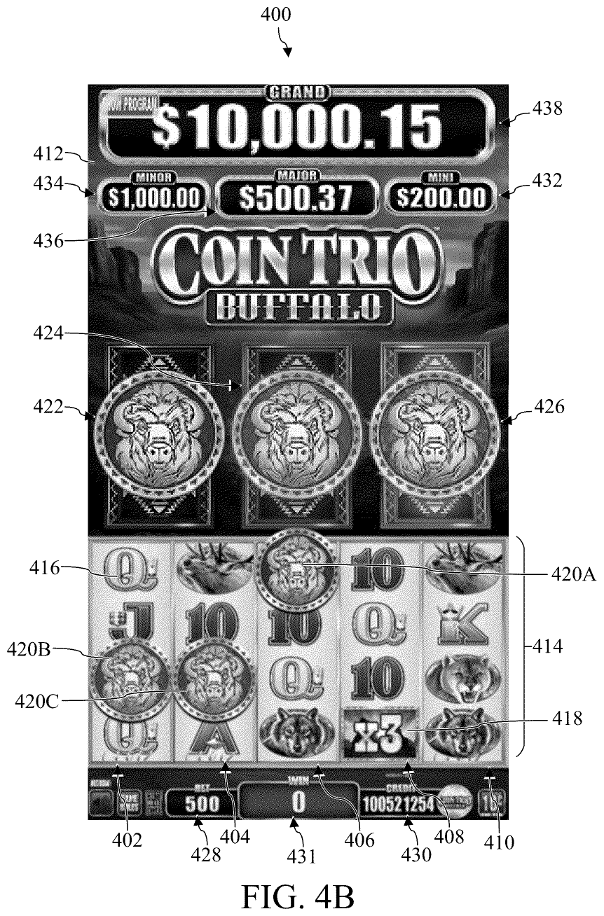

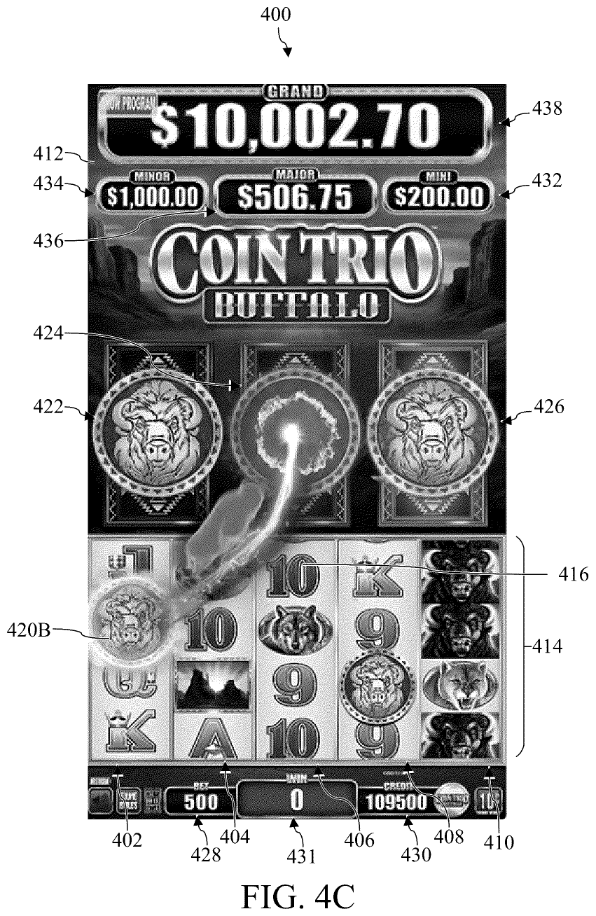

FIGS. 4A-4C are example user interfaces or screenshots of an example base reel game 400 played on a gaming device (e.g., gaming devices 104A-104X in FIG. 1, and/or gaming device 200 and/or mobile gaming device 256 in FIG. 2B). Specifically, FIGS. 4A-4C show base reel game 400, in which a base reel game outcome is displayed that corresponds to (e.g., presents, represents, and/or is determined from) an output of the gaming device. The output may be a primary game outcome determined in response to a wager received from a player. In example implementations, the primary game outcome is a Class II (e.g., bingo) game outcome or a Class III or Las-Vegas style game outcome. In various implementations, the base reel game 400 may be implemented to present an outcome of any suitable game of chance. Specific details of the type of primary or base reel game outcomes presented using the base reel game 400 are not central to an understanding of the present disclosure. However, additional detail related to at least one implementation (e.g., an implementation employing the base reel game 400 to present a primary bingo-based or Class II game outcome) may be obtained with reference to U.S. Published Patent Application No. 2012/0270638, filed Apr. 20, 2011, and entitled GAMING MACHINE WITH FREE PLAY BONUS MODE PRESENTING ONLY WINNING OUTCOMES, the disclosure of which is hereby incorporated by reference herein in its entirety.

The base reel game 400 may be initiated on a gaming device 104A-104X, 200 and/or mobile gaming device 256. For example, a player may fund the base reel game 400 via bill validator 234 and/or ticket reader 224. Once funded, the base reel game 400, which includes a first plurality of reels 402, 404, 406, 408, and/or 410, each including a plurality of game symbols 414 that appear on a display device 412. The plurality of reels 402-410 of the example base reel game 400 includes five (5) reels. In other examples, the number of reels may range from one reel to five or more reels. The base reel game 400 may be played on display device 412. However, in other implementations, the base reel game 400 may be played on several displays including display device 412 and one or more additional or auxiliary displays.

In the example shown in FIGS. 4A-4C, the base reel game 400 includes a first reel matrix on the primary display device 412. The first reel matrix includes a plurality of symbol arrangements or positions arranged in a plurality of rows and a plurality of columns. The first reel matrix may also therefore be referred to as a “matrix of symbol positions” or “matrix of symbol arrangements.” While, in the example shown in FIGS. 4A-4C, the first reel matrix is displayed on the primary display device 412, the first reel matrix may appear in other locations on an EGM 104A-104X and/or on other displays, such as, for example, the secondary display, a display of button deck 120, and the like. In the example embodiment shown in FIGS. 4A-4C, the plurality of reels 402-410 form five distinct reels and/or five columns. Each reel 402-410 also includes a number of rows as well. In the exemplary embodiment, reels 402-410 have four (4) rows. As a result, the plurality of reels 402-410 for base reel game 400 include a 4×4×4×4×4 arrangement, as depicted on display device 412, and include twenty (20) game symbol positions. In other implementations, the plurality of reels 402-410 may be any size/uniformity/arrangement (e.g., 2×2, 3×3, 4×4, 10×10, etc.), and a number of game symbol positions for the plurality of reels 402-410 may vary depending upon a number of rows and columns of the plurality of reels 402-410.

As described herein, during play of the base reel game 400, game symbols 414 may be selected (e.g., such as from the plurality of reels 402-410) and displayed in the game symbol positions of each column and row of the plurality of reels 402-410. The game symbols 414 displayed after spinning and stopping each reel strip in a respective column of the plurality of reels 402-410 may be referred to herein as a “reel outcome” or a “base reel game outcome” or a “base game outcome.” More broadly, an “outcome” of a reel game, such as a base reel game (e.g., the base reel game 400) refers to the game symbols 414 displayed in the plurality of reels 402-410 after reel strips are spun and stopped. Thus, a rotation and stopping of a plurality of reel strips (also referred to herein as a “spin and stop sequence”) may be simulated by processor 204 within the columns of the plurality of reels 402-410 to cause a reel outcome, including a plurality of game symbols 414, to be displayed from the plurality of reel strips within the columns of the plurality of reels 402-410.

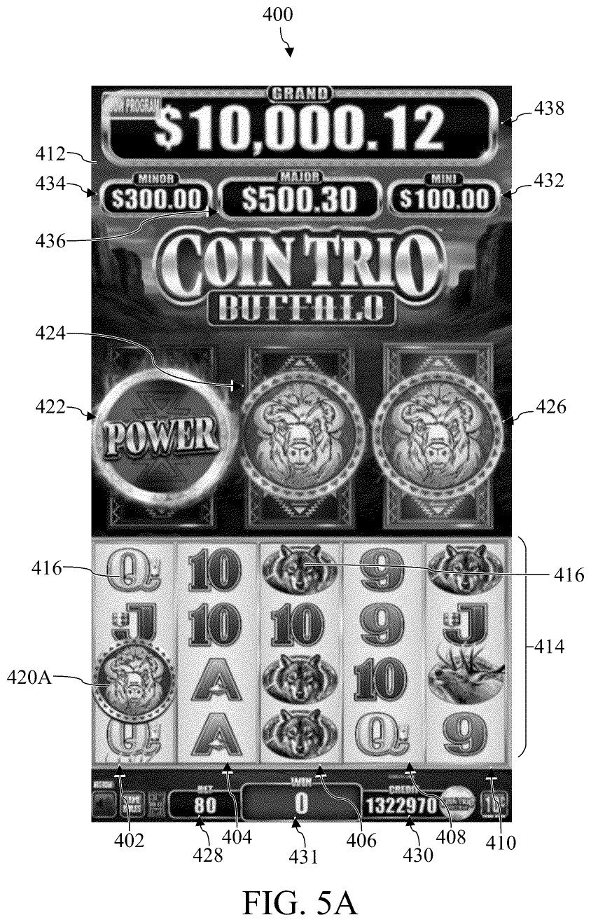

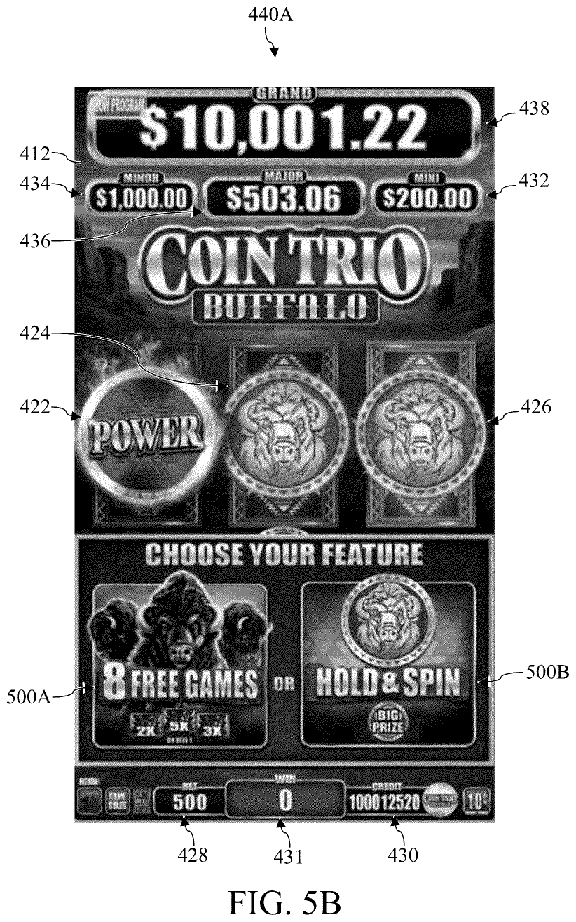

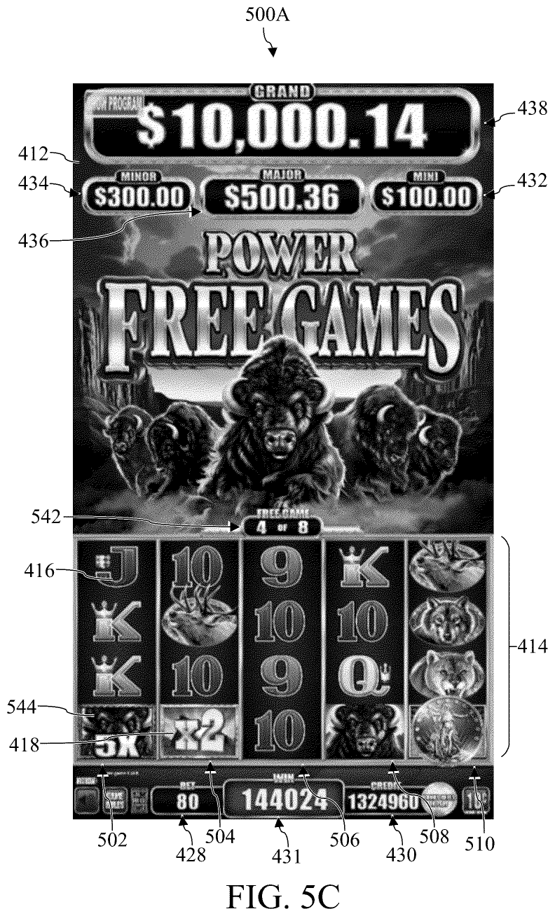

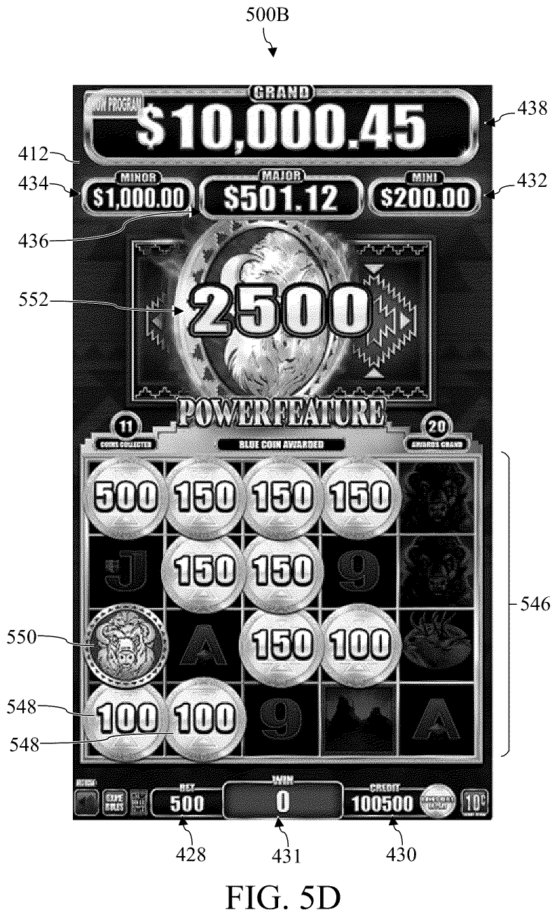

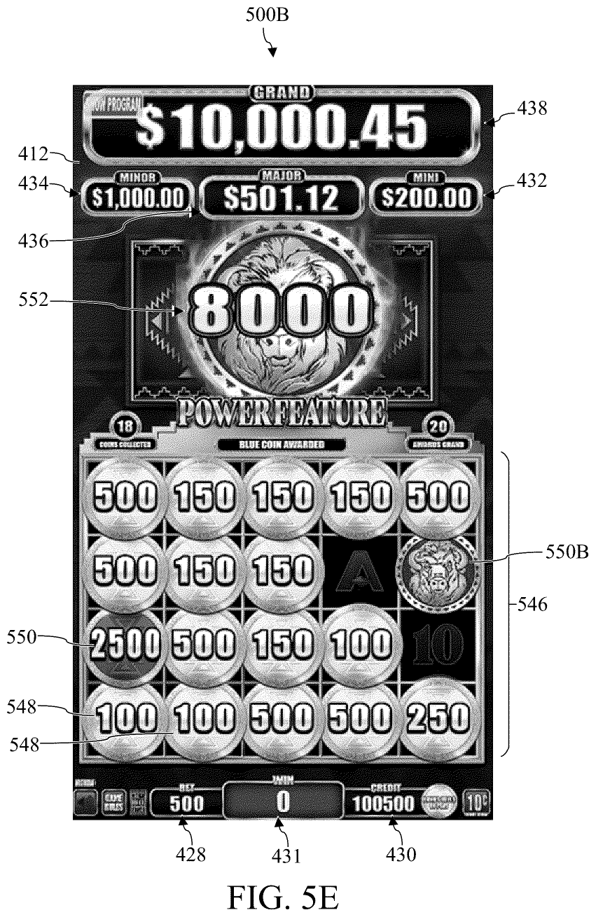

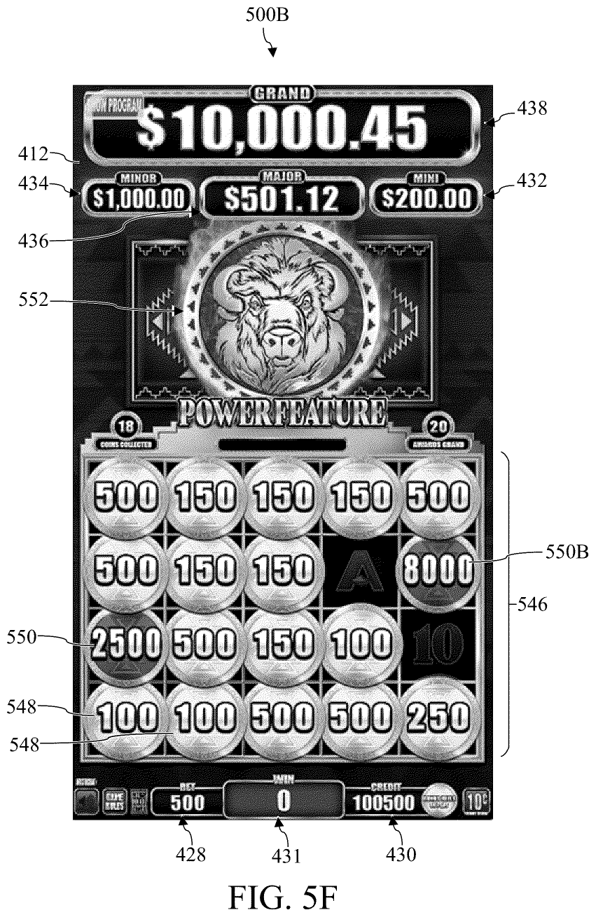

As shown in the exemplary embodiment of FIGS. 4A-4C, and as discussed herein, the plurality of game symbols 414 included and/or displayed within the plurality of reels 402-410 include and/or are formed from various symbol types. For example, graphic game symbols 416 of the plurality of game symbols 414 include predetermined graphics, symbols, and/or art works that can be based on a theme, story, and/or visual representation of base reel game 400. Additionally, or alternatively, graphic game symbols include suitable graphics, symbols, and/or artworks commonly associated with gaming device (e.g., “BAR,” “SPIN,” “WILD,” etc.). Collectively, these game symbols 414 are referred to herein as graphic symbols 416. Additionally, the plurality of game symbols 414 include cash-on-reel (COR) symbols (see, FIG. 5D) displayed within the plurality of reels 402-410. COR symbols include, display, depict, and/or are associated with a predetermined credit value (e.g., COR credit value) that can provide additional award credits to the player during base reel game 400, as discussed herein. The plurality of game symbols 414 can also include jackpot symbols (not shown), which include, display, depict, and/or are associated with jackpots, as discussed herein. That is, jackpot symbols can provide additional award credits to the player during base reel game 400. Furthermore, the plurality of game symbols 414 also include base game multiplier symbols 418 (see, FIG. 4B) including and/or depicting a multiplier number. In exemplary embodiments, multiplier symbols 418 that land in a winning base game outcome and/or within a winning payline for base reel game 400 can multiple the total credit values awarded to the player by the depicted amount.

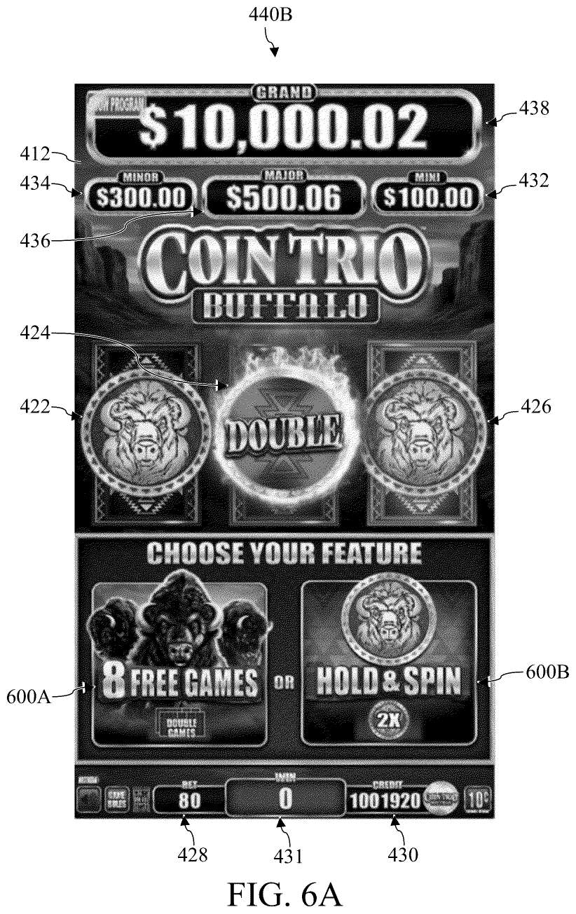

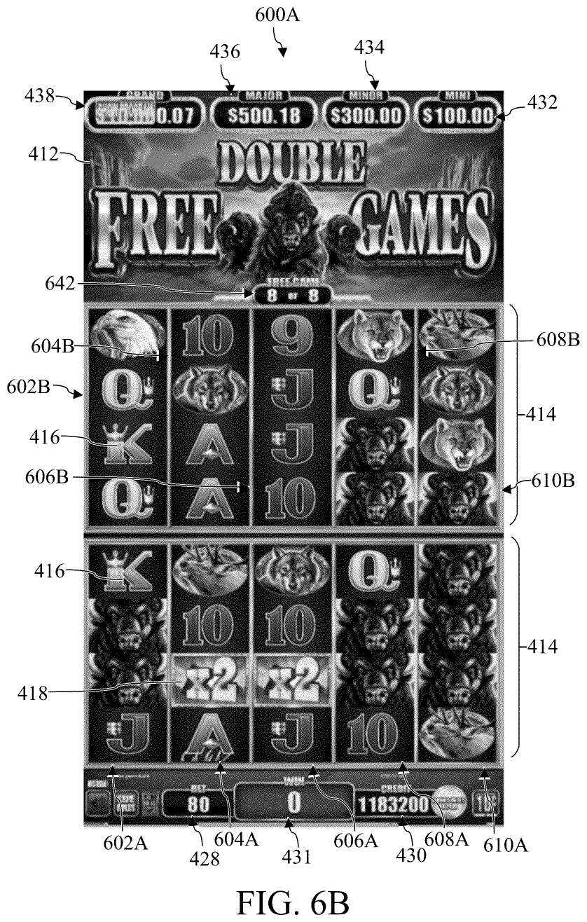

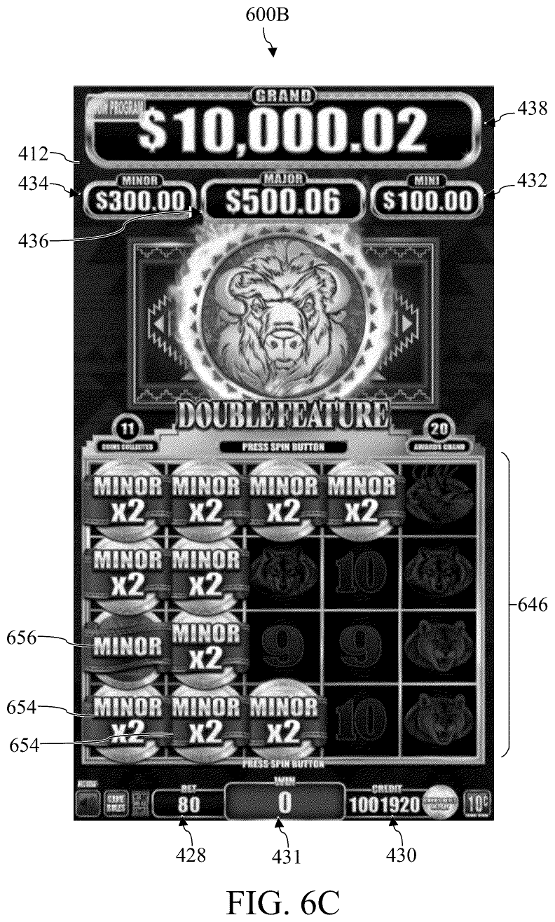

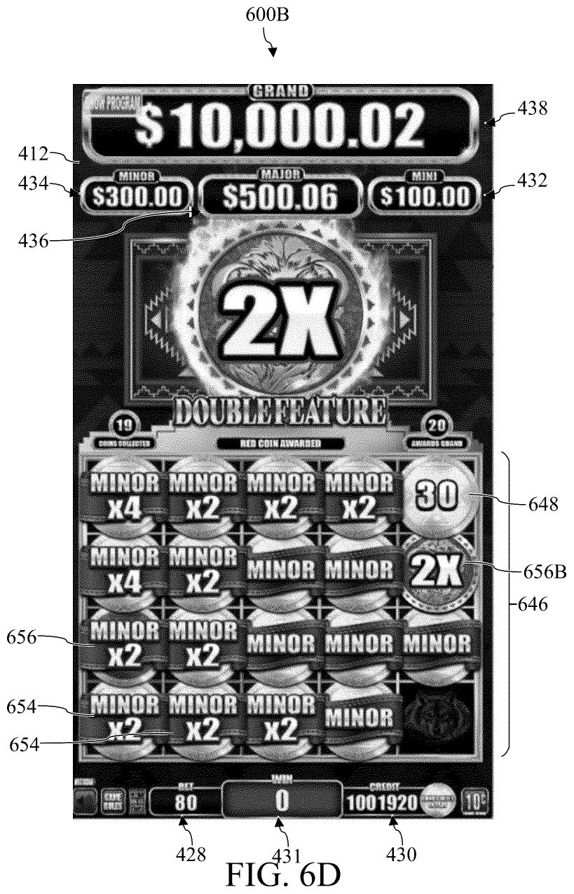

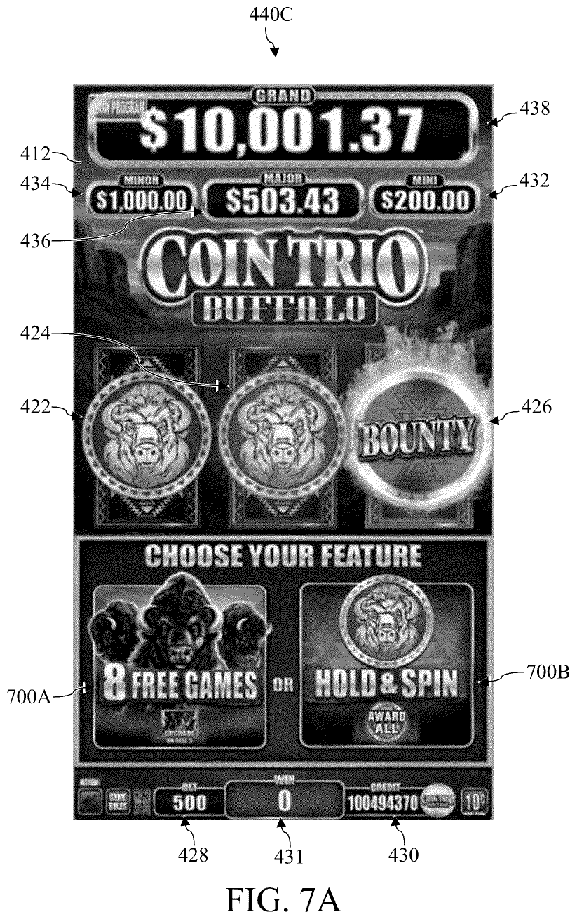

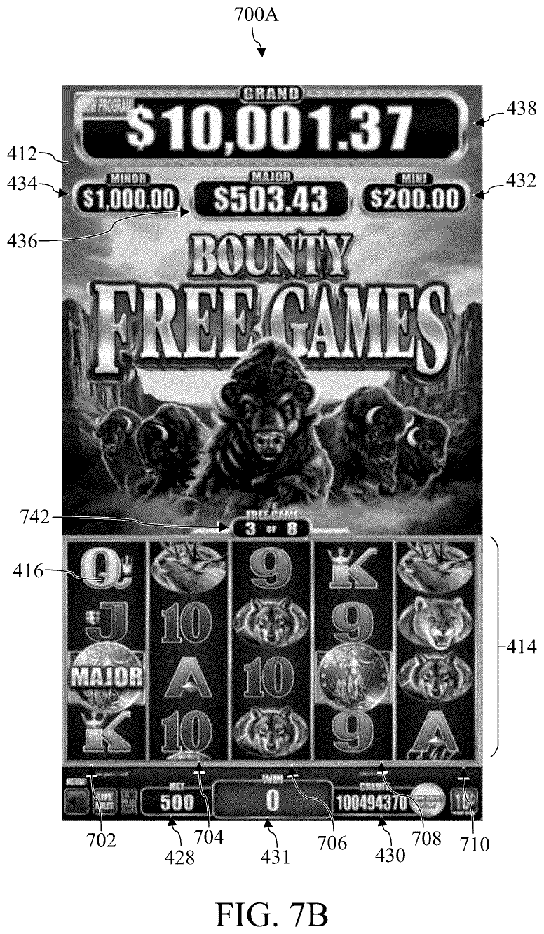

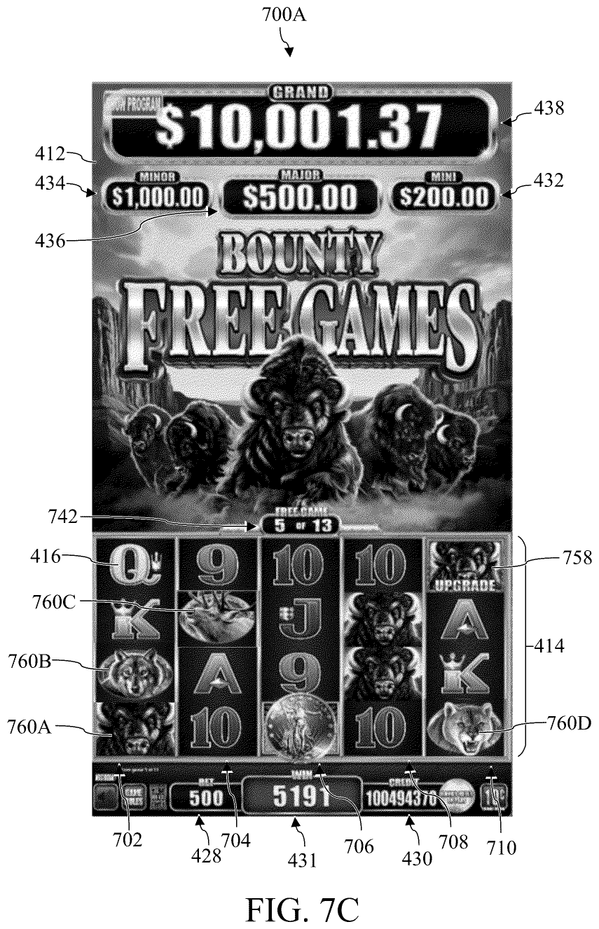

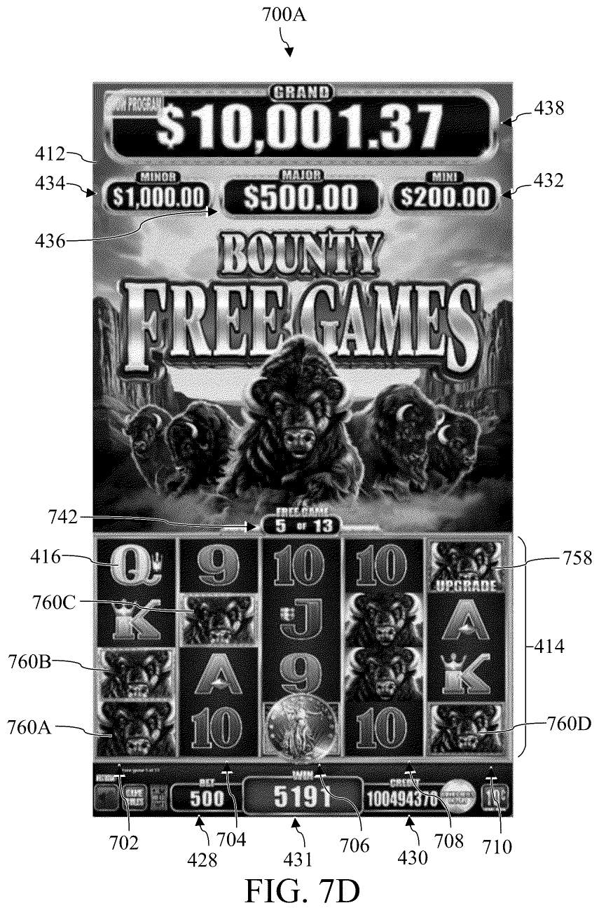

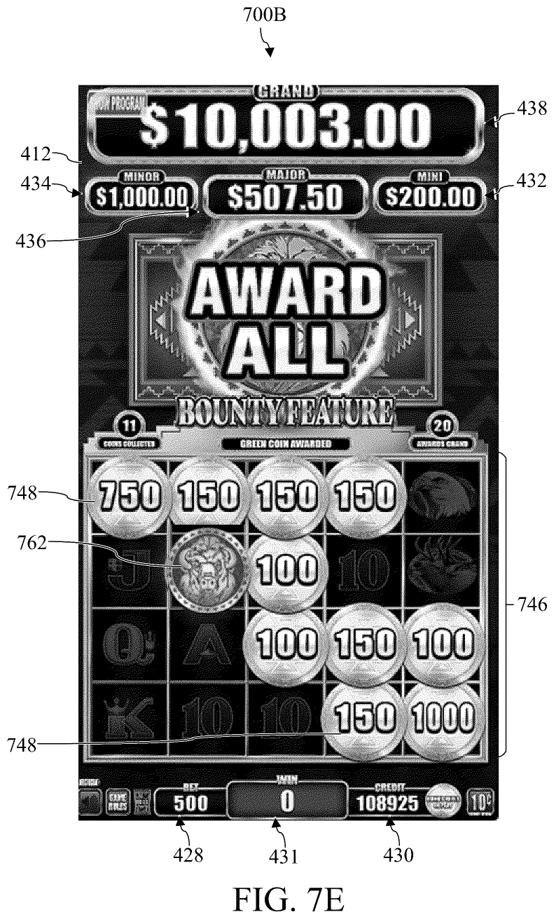

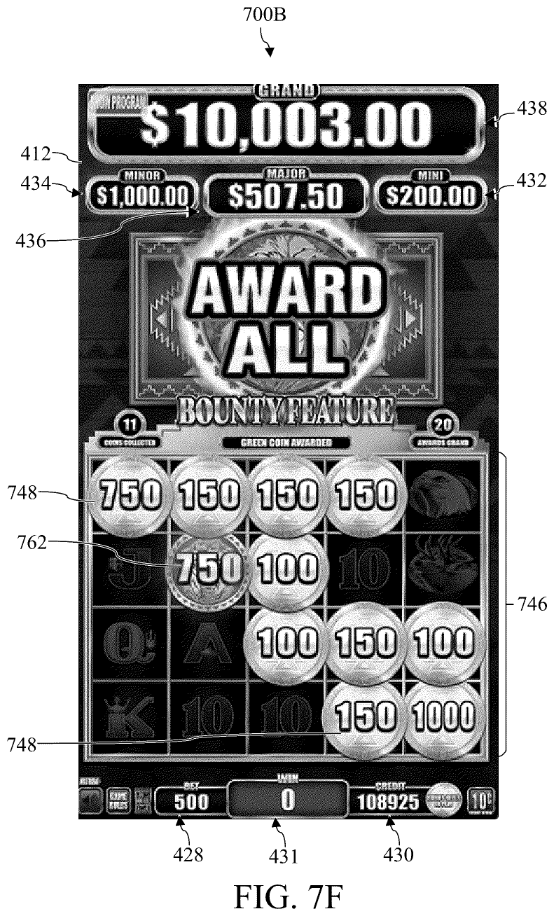

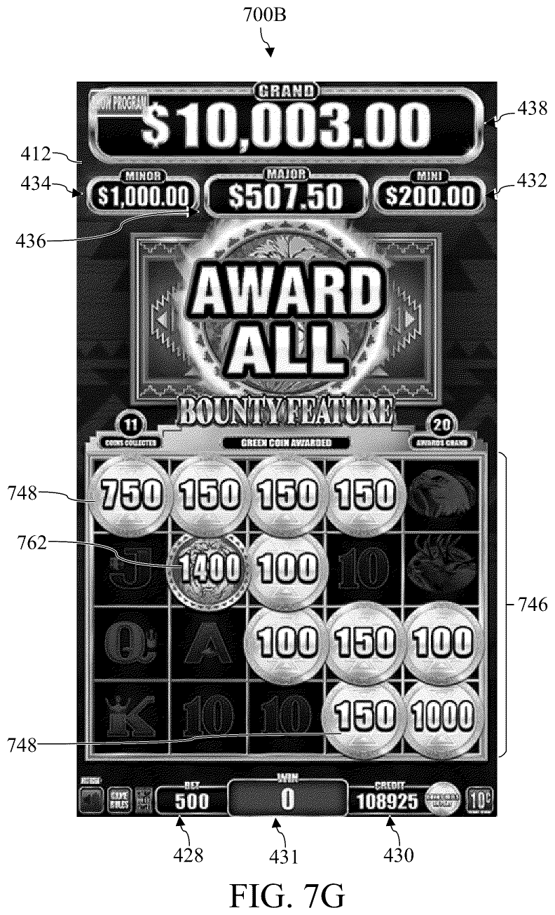

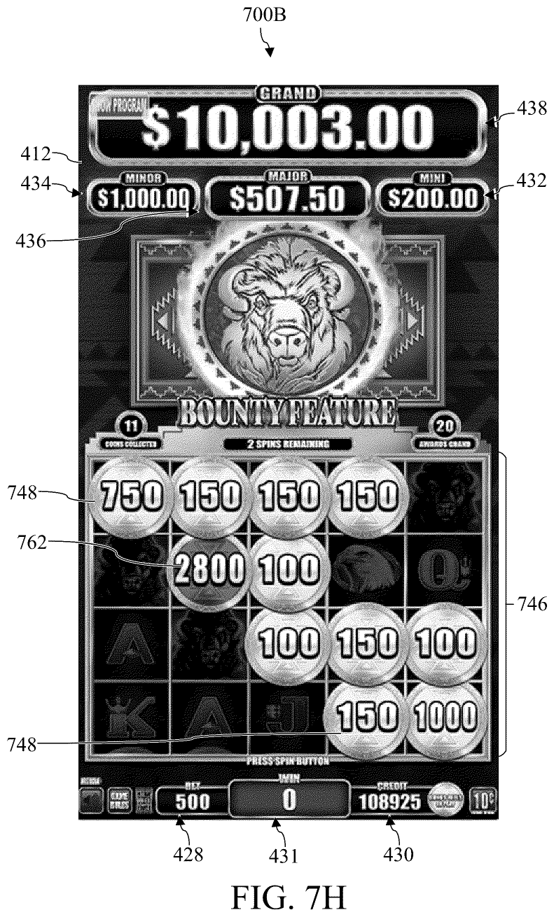

In exemplary embodiments, and as shown in FIGS. 4B and 4C, the plurality of game symbols 414 also include a plurality of metamorphic enhancement feature symbols 420. Metamorphic enhancement feature symbols 420 are associated with a particular metamorphic enhancement feature (e.g., power feature, double feature, bounty feature) for bonus games 500, 600, 700, as discussed herein. More specifically, metamorphic enhancement feature symbol 420A corresponds to metamorphic 422 associated with a power feature during bonus games 500A, 500B (see, FIGS. 5A-5F), metamorphic enhancement feature symbol 420B corresponds to metamorphic 424 associated with a double feature during bonus games 600A, 600B (see, FIGS. 6A-6D), and metamorphic enhancement feature symbol 420C corresponds to metamorphic 426 associated with bounty feature during bonus games 700A, 700B (see, FIGS. 7A-7H).

The plurality of metamorphics 422-426 is displayed on display 412 of an EGM 104A-104X or 200, whereby the plurality of metamorphics 422-426 appear above and/or adjacent to the plurality of reels 402-410. Each metamorphic 422-426 is associated with an enhancement feature of the bonus games 500A-700B. In exemplary embodiments, the base reel game 400 displays three metamorphics 422-426. These include a power feature metamorphic 422, a double feature metamorphic 424, and a bounty feature metamorphic 426. Although three metamorphics 422-426 are shown and described, it will be appreciated that any suitable number of metamorphics may be included in base reel game 400 and/or bonus games 500A-700B. For example, the number of metamorphics may vary to match a number of potential enhancement features of the bonus reel game.

The metamorphics 422-426 may be used in conjunction with the enhancement feature symbols 420 that are displayed in the plurality of reels 402-410 to provide a visual representation indicating that the bonus games 500A-700B has been triggered based on the base reel game outcome. In particular, each enhancement feature symbol 420 is associated with one of the metamorphics 422-426, where a common enhancement feature is associated with the enhancement feature symbol 420 and the metamorphic 422-426. During the base reel game 400, each metamorphic 422-426 may be in an inactive state. For example, each metamorphic 422-426 is a unique graphic and, in the inactive state, the unique graphic is displayed with no additional accents or animations. In response to an enhancement feature symbol 420 being displayed in the plurality of reels 402-410 in a base reel game outcome of the base reel game 400, the associated metamorphic 422-426 is transformed to either an intermediate state or an active state. In non-limiting examples, in the intermediate state the graphic representing each metamorphic can move and/or grow in size, and in an active state the graphic can perform secondary movement (e.g., explode, or flip) or grow to a maximum size.

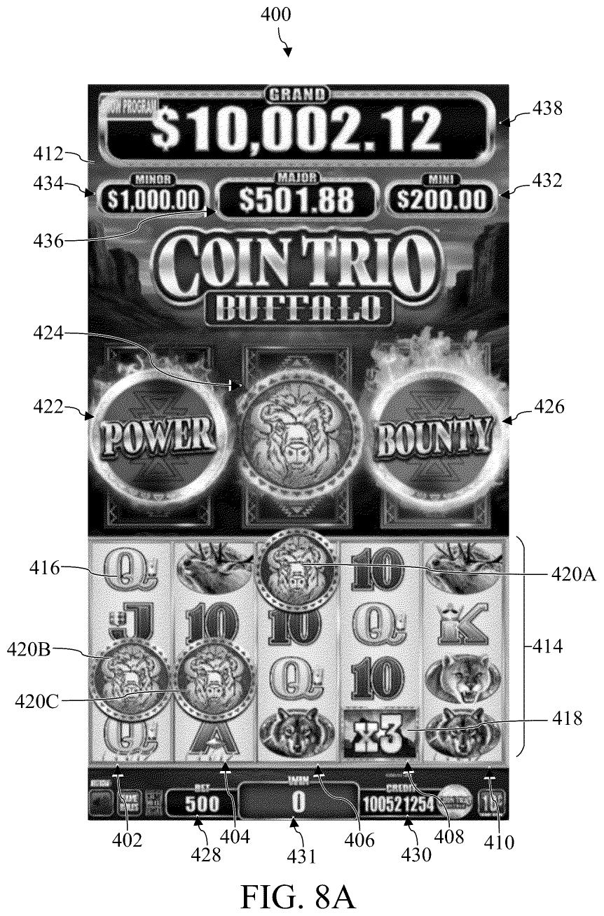

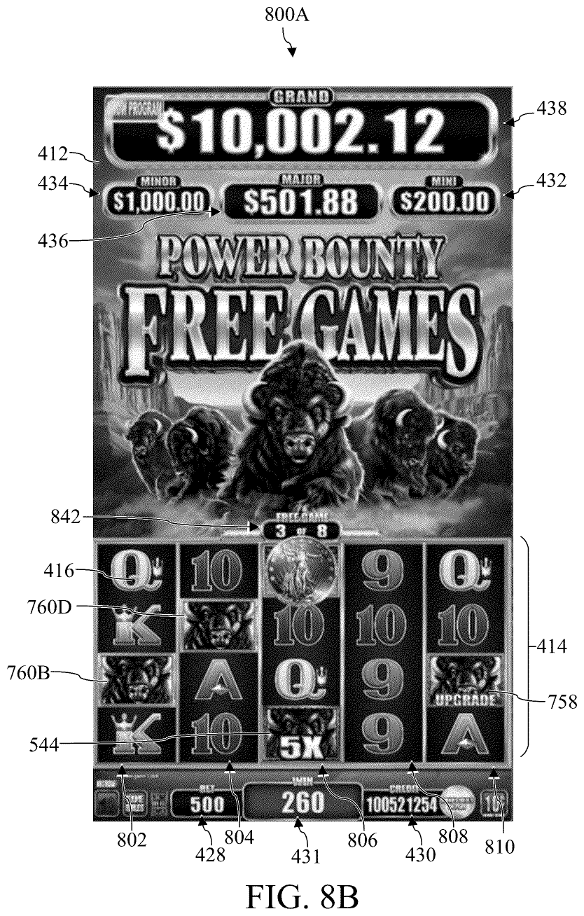

Whether the associated metamorphic 422-426 transforms to the intermediate state or the active state may be determined based on whether the bonus game 500A-700B is triggered in conjunction with the display of the enhancement feature symbol (i.e., whether a primary game outcome presented by the outcome of the base game 400 also triggers the bonus games 500A-700B). If the bonus games 500A-700B are not triggered, the metamorphic 422-426 associated with an enhancement feature symbol 420 in the plurality of reels 402-410 transforms to the intermediate state. By transforming the metamorphic 422-426 to the intermediate state (e.g., moves and/or grows in size), the player perceives that the opportunity for a bonus game 500A-700B having the enhancement feature associated with the transformed metamorphic 422-426 has increased. If the bonus game 500A-700B is triggered, the metamorphic 422-426 associated with an enhancement feature symbol in the plurality of reels 402-410 transforms to the active state (e.g., graphic grows, moves, explodes, flips, etc.). By transforming the metamorphic 422-426 to the active state, the player is informed that bonus game(s) 500A-700B having the enhancement feature associated with the transformed metamorphic 422-426 has been triggered. Additionally, the player perceives, via the visual representation, that the enhancement feature symbol 420 being displayed in the plurality of reels 402-410 triggers the associated enhancement feature of bonus game(s) 500A-700B. If multiple enhancement feature symbols 420A, 420B, 420C are displayed in the plurality of reels 402-410, each associated metamorphic 422-426 is transformed to either the intermediate state or the active state, depending on whether the bonus game(s) 500A-700B are triggered (see, FIGS. 8A and 8B). Further, a visual representation that the transformation of the metamorphic 422-426 is caused by the associated enhancement feature symbol 420 being displayed in the plurality of reels 402-410 may be provided, such as by moving the enhancement feature symbol up toward the associated metamorphic 422-426 before and/or during the metamorphic 422-426 being transformed. In exemplary embodiments, when enhancement feature symbols 420 are included in the base reel game outcome, themed animations, story-based graphics, and/or visual representations specific to base reel game 400 can also be depicted on display 412 to represent to the player that each metamorphic 422-426 is transforming to and/or is closer to the active state. As shown in FIG. 4C, an animation depicting a buffalo including a color representative of and/or associated with the specific enhancement feature symbol 420B and/or metamorphic 424 travels, runs, and/or moves from enhancement feature symbol 420B to metamorphic 424 on display 412.

The plurality of reels 402-410, as well as graphic game symbols 416, multiplier symbols 418, and enhancement feature symbol 420, are all defined in a single, base reel game reel table. More specifically, a single, base reel game table defines each reel of the plurality of reels 402-410 used in base reel game 400, the number of reel stop positions in each reel 402-410, the reel stop position of each of the plurality of graphic game symbols 416/multiplier symbols 418/enhancement feature symbol 420 within each reel 402-410, and the like. In exemplary embodiments, the single, base reel game reel table defining the plurality of reels 402-410 for base reel game 400 are stored in RNG conversion engine 320 (see, FIG. 3). As discussed herein, no reels are shared between base reel game 400 and any of the other bonus games 500A-700B.

Base reel game 400 also includes a wager meter 428, and a credit meter 430 depicted on display device 412. Wager meter 428 represents and/or displays the credit and/or monetary value being wagered during each play of base reel game 400, as determined by the player. Credit meter 430 displays a credit balance (calculated as a sum total of credits input and awards accrued minus wagers placed) accrued until a player cashes out. As shown in FIGS. 4A-4C, a win meter 431 is also displayed in base reel game 400. As discussed herein, win meter 431 displays a credit and/or monetary value awarded during outcomes of the base reel game 400 and/or bonus games 500A-700B, as discussed herein.

In exemplary embodiments, base reel game 400 also displays a plurality of “jackpot” bonuses 432-438 on display device 412. For example, jackpot bonus 432 includes a “mini” jackpot value, jackpot bonus 434 includes a “minor” jackpot value, jackpot bonus 436 includes a “major” jackpot value, and jackpot bonus 438 includes a “grand” jackpot value. As discussed herein, each jackpot bonus 432-438 correspond to and/or is correlated with at least one jackpot symbol displayed in the base reel game outcome of base reel game 400 and/or bonus game outcome for bonus games 500A-700B. Additionally, the credit value associated with each jackpot bonus 432-438 may be a predetermined credit value. Alternatively, jackpot bonuses 432-438 include progressive credit values that are dependent upon, at least in part, the credit and/or monetary value being wagered during each play of base reel game 400 (e.g., wager meter 428), the number of consecutive base reel games 400 played prior to triggering bonus games 500A-700B, and the like.

FIGS. 5A-5F are exemplary user interfaces or screenshots after the triggering and/or activation of metamorphic 422 relating to the power feature, and subsequent playing of bonus games 500A, 500B. More specifically, FIG. 5A is an exemplary user interface or screenshot after metamorphic 422 has been triggered and/or activated as a result of the base reel game outcome including enhancement feature symbol 420A in reel 402. Additionally, as shown in FIG. 5A, the graphic representing metamorphic 422 is changed, adjusted, and/or altered from the previous “buffalo coin” (see, FIGS. 4A-4C) to now depict “POWER.” Such a transformation of metamorphic 422 indicates to the player that bonus games 500A, 500B associated with metamorphic 422 are triggered.

The base reel game outcome for base reel game 400 is determined using a single, base reel game outcome table. That is, each base reel game outcome for base reel game 400 is determined, defined, and/or identified using a single base reel game outcome table that is in communication with and/or utilized in conjunction with the single base reel game reel table. In exemplary embodiments, when determining the outcome for base reel game 400, and more specifically determining if bonus games 500A, 500B (and/or bonus games 600A-700B, as discussed herein) have been triggered, only the single base reel game reel table and single base reel game outcome table are queried and/or pulled. Additional and/or distinct reel tables and/or outcome tables included in game processing architecture 300 (FIG. 3) included in EGMs 104 are not queried and/or pulled, as discussed herein.

FIG. 5B is an exemplary user interface or screenshot after metamorphic 422 has been triggered and/or activated, and includes a bonus game pick screen 440A. In the exemplary embodiment, the player is provided the option of choosing between two distinct bonus games 500A, 500B. Selectable, first bonus game 500A includes a predetermined number of free plays of a power feature free spin bonus game 500A combined with award enhancing multiplier bonus symbols (see, FIG. 5C). Selectable second bonus game 500B includes a power feature hold-and-spin bonus game 500B (see, FIGS. 5D-5F). In exemplary embodiments, the predetermined number of free plays (e.g., no credits required or added by the player) of power feature free spin bonus game 500A is eight (8) free plays and the award enhancing multiplier bonus symbols include 2×, 3×, and 5× multipliers. However, it is to be understood that power feature free spin bonus game 500A can include any predetermined number of free plays and/or any value and combination of multiplier bonus symbols (e.g., 4×, 8×, 10×, etc.). As discussed herein, and as a result of triggering metamorphic 422 associated with the power feature, and corresponding to enhancement feature symbol 420A, each of power feature free spin bonus game 500A and power feature hold-and-spin bonus game 500B includes unique game play features.

FIG. 5C is an exemplary user interface or screenshot of power feature free spin bonus game 500A. Specifically, FIG. 5C is an exemplary user interface or screenshot after power feature free spin bonus game 500A is initiated after playing base reel game 400 (see, FIG. 5A), after triggering bonus game pick screen 440A (see, FIG. 5B), and after the player selects and subsequently plays power feature free spin bonus game 500A, respectively. Power feature free spin bonus game 500A includes a free game indicator 542. Prior to spinning a plurality of power feature reels 502-510 (hereafter, “reels 502-510”) included in power feature free spin bonus game 500A, pick indicator 542 displays and/or presents the predetermined number of free game plays for power feature free spin bonus game 500A. In the exemplary embodiment, the predetermined number of free games is eight “8” free games for power feature free spin bonus game 500A. However, and as shown in FIG. 5C, display 412 depicts the fourth outcome for power feature free spin bonus game 500A, as the player has already spun reels 502-510 and/or played power feature free spin bonus game 500A four times. As a result, free game indicator 542 depicts or shows “4 of 8” for the free game plays of power feature free spin bonus game 500A.

Power feature free spin bonus game 500A displayed on display 412 includes the plurality of power feature reels 502-510, which are distinct from those reels 402-410 included in base reel game 400. Additionally, each reel 502-510 included in power feature free spin bonus game 500A includes the plurality of game symbols 414 including graphic game symbols 416 and/or multiplier symbols 418. In exemplary embodiments, reels 502-510 included in power feature free spin bonus game 500A include substantially similar game symbols 414. Alternatively, reels 502-510 included in power feature free spin bonus game 500A include distinct game symbols 414.

In the exemplary embodiment, and as a result of triggering metamorphic 422 relating to the power feature, the plurality of game symbols 414 included in reels 502-510 of power feature free spin bonus game 500A can also include at least one multiplier bonus symbol 544. Multiplier bonus symbol 544 when displayed in the outcome of any of the free game plays of power feature free spin bonus game 500A can multiple a winning or awarded credit value by a predetermined factor. That is, multiplier bonus symbol 544 included in power feature free spin bonus game 500A can include a predetermined multiplying factor displayed thereon. When multiplier bonus symbol 544 is displayed in the outcome of power feature free spin bonus game 500A, awarded credit values are multiplied by the associated, predetermined factor displayed on multiplier bonus symbol 544 before being awarded to the player. In the exemplary embodiment shown in FIG. 5C, multiplier bonus symbol 544 is included within power feature free spin bonus game 500A and includes a predetermined multiplying factor of five (5) (“5×”). Although shown as a factor of five (“5×”), it is understood that the predetermined multiplying factor for multiplier bonus symbol 544 can include any predetermined number or factor (see, FIG. 5C; “2×, 3×, 5×”). Additionally, although one multiplier bonus symbol 544 is shown in the outcome of reels 502-510 for power feature free spin bonus game 500A, it is understood that reels 502-510 can include a plurality of multiplier bonus symbols 544 during power feature free spin bonus game 500A.

The plurality of reels 502-510, as well as graphic game symbols 416, multiplier symbols 418, and multiplier bonus symbol 544, are all defined in a single, power feature free spin reel table. More specifically, a single, power feature free spin reel table defines each reel of the plurality of reels 502-510 used in power feature free spin bonus game 500A, the number of reel stop positions in each reel 502-510, the reel stop position of each of the plurality of graphic game symbols 416/multiplier symbols 418/multiplier bonus symbol 544 within each reel 502-510, and the like. In exemplary embodiments, the power feature free spin reel table defining the plurality of reels 502-510 for power feature free spin bonus game 500A are stored in RNG conversion engine 320 (see, FIG. 3), separate from the single base reel game reel table, for example.

Additionally, the power feature free spin outcome for power feature free spin bonus game 500A is determined using a single, power feature free spin outcome table. That is, each power feature outcome for power feature free spin bonus game 500A is determined, defined, and/or identified using a single power feature free spin outcome table that is in communication with and/or utilized in conjunction with the single power feature free spin reel table. In exemplary embodiments, when determining the outcome for power feature free spin bonus game 500A, only the single power feature free spin reel table and single power feature free spin outcome table are queried and/or pulled. Distinct reel tables and/or outcome tables included in game processing architecture 300 (FIG. 3) included in EGMs 104 are not queried and/or pulled, as discussed herein.

Referring to FIGS. 5D-5F, exemplary user interfaces or screenshots of a sequence of power feature hold-and-spin bonus game 500B initiated after playing base reel game 400 (see, FIG. 5A) are displayed. Specifically, FIGS. 5D-5F are exemplary user interfaces or screenshots after power feature hold-and-spin bonus game 500B is initiated after playing base reel game 400 (see, FIG. 5A), after triggering bonus game pick screen 440A (see, FIG. 5B), and after the player selects and subsequently plays power feature hold-and-spin bonus game 500B, respectively. In exemplary embodiments, power feature hold-and-spin bonus game 500B includes a plurality of power feature hold-and-spin reels 546 (hereafter, “reels 546”) displaying a plurality of COR symbols 548. Prior to “spinning” the plurality of reels 546, a spin number indicator (not shown) can display and/or present a predetermined number of bonus spins for power feature hold-and-spin bonus game 500B. In exemplary embodiments, the predetermined number of bonus spins for power feature hold-and-spin bonus game 500B is three (3). The user or player of power feature hold-and-spin bonus game 500B “spins” the plurality of reels 546 to attempt to display additional COR symbols 548 thereon. Each spin in which one or more COR symbol 548 lands or is displayed on at least one reel 546 of power feature hold-and-spin bonus game 500B resets the spin number indicator back to the predetermined number of spins for power feature hold-and-spin bonus game 500B. In another non-limiting example, the number of bonus spins are not reset in response to displaying COR symbols 548 during power feature hold-and-spin bonus game 500B. Rather, the player can spin power feature hold-and-spin bonus game 500B the predetermined number of spins (e.g., three spins), before power feature hold-and-spin bonus game 500B ends.

FIG. 5D is an exemplary user interface or screenshot of an outcome of power feature hold-and-spin bonus game 500B. That is, FIG. 5D is an exemplary embodiment after the player has spun the plurality of reels 546 of power feature hold-and-spin bonus game 500B at least once to display a plurality of COR symbols 548 thereon.

Additionally, or alternatively, at least a portion of COR symbols 548 displayed in power feature hold-and-spin bonus game 500B are pre-populated. For example, a predetermined or random number of spaces included in the plurality of reels 546 in power feature hold-and-spin bonus game 500B are pre-populated prior to performing the first spin of power feature hold-and-spin bonus game 500B. In exemplary embodiments, the position of pre-populated COR symbols 548 within reels 546 are random, or alternatively correspond to specific game symbols 414 displayed in the base reel game outcome.

Additionally, as shown in the exemplary embodiment, the plurality of reels 546 of power feature hold-and-spin bonus game 500B include at least one power feature bonus symbol 550. That is, after spinning the plurality of reels 546, power feature bonus symbol 550 may be displayed, depicted, and/or included in reels 546 and/or in the outcome of power feature hold-and-spin bonus game 500B. As a result of power feature bonus symbol 550 being depicted in reels 546 during power feature hold-and-spin bonus game 500B, a credit value is generated and/or associated with displayed power feature bonus symbol 550. In the exemplary embodiments, a graphic or animation 552 depicted on display 412, above the plurality of reels 546, can present, display, and/or depict a randomly generated credit value to be awarded, associated with, and/or correspond to power feature bonus symbol 550 during power feature hold-and-spin bonus game 500B. As shown in FIG. 5E, a “buffalo coin” (e.g., game theme) can rotate and display random and/or increasing credit values until a final credit value is associated with displayed power feature bonus symbol 550. As shown, the generated and/or associated credit value is “2500.” The generated credit value is subsequently added to and/or overlaps displayed power feature bonus symbol 550 (see, FIG. 5E), and remains displayed, along with previously displayed COR symbols 548 during subsequent game play of power feature hold-and-spin bonus game 500B.

FIGS. 5E and 5F show exemplary embodiments after the player has performed additional spins the plurality of reels 546 during the game play of power feature hold-and-spin bonus game 500B. In the non-limiting examples, additional COR symbols 548 are displayed on reels 546. Furthermore, and as shown in FIG. 5E, a distinct power feature bonus symbol 550B is displayed, depicted, and/or included in reels 546 and/or in the outcome of power feature hold-and-spin bonus game 500B. As a result of distinct power feature bonus symbol 550B being depicted in reels 546 during power feature hold-and-spin bonus game 500B, a credit value is generated and/or associated with displayed power feature bonus symbol 550B, as similarly discussed herein with respect to power feature bonus symbol 550 (see, FIG. 5D). As discussed herein, animation 552 depicted on display 412 can present, display, and/or depict a randomly generated credit value to be awarded, associated with, and/or correspond to distinct power feature bonus symbol 550B during power feature hold-and-spin bonus game 500B. As shown in FIG. 5E, “buffalo coin” (e.g., game theme) can rotate and display random and/or increasing credit values until a final credit value is associated with displayed, distinct power feature bonus symbol 550B. As shown, the generated and/or associated credit value is “8000.” The generated credit value is subsequently added to and/or overlaps displayed, distinct power feature bonus symbol 550B, as shown in FIG. 5F, and remains displayed, along with previously displayed COR symbols 548 during subsequent game play of power feature hold-and-spin bonus game 500B.

At the end of power feature hold-and-spin bonus game 500B, the credit values corresponding to and/or included with COR symbols 548 and/or power feature bonus symbols 550, 550B displayed in reels 546 are added to win meter 431.

In non-limiting examples, the generated credit value for each displayed power feature bonus symbol 550, 550B is random and/or predetermined. In other exemplary embodiments, as each distinct power feature bonus symbol 550, 550B is displayed during power feature hold-and-spin bonus game 500B, credit values generated and/or associated for subsequently displayed power feature bonus symbols 550 can remain the same or increase. For example, and with reference to FIGS. 5D-5F, the generated credit value for distinct (or second) power feature bonus symbol 550B is greater than the generated credit value for (first) power feature bonus symbol 550 as a result of the first power feature bonus symbol 550 being displayed prior to the second power feature bonus symbol 550B during power feature hold-and-spin bonus game 500B.

The plurality of power feature hold-and-spin reels 546, as well as COR symbols 548 and power feature bonus symbol 550, are all defined in a single, power feature hold-and-spin reel table - distinct from power feature free spin reel table defining reels 502-510. More specifically, a single, power feature hold-and-spin reel table defines each reel of the plurality of reels 546 used in power feature hold-and-spin bonus game 500B, the number of reel stop positions in each reel 546, the reel stop position of each of the plurality of COR symbols 548/power feature bonus symbol 550 within each reel 546, and the like. In exemplary embodiments, the power feature hold-and-spin reel table defining the plurality of reels 546 for power feature hold-and-spin bonus game 500B are stored in RNG conversion engine 320 (see, FIG. 3), separate from the single base reel game reel table and the power feature free spin reel table, respectively.

Additionally, the power feature hold-and-spin outcome for power feature hold-and-spin bonus game 500B is determined using a single, power feature hold-and-spin outcome table. That is, each outcome for power feature hold-and-spin bonus game 500B is determined, defined, and/or identified using a single power feature hold-and-spin outcome table that is in communication with and/or utilized in conjunction with the single power feature hold-and-spin reel table. In exemplary embodiments, when determining the outcome for power feature hold-and-spin bonus game 500B, only the single power feature hold-and-spin reel table and single power feature hold-and-spin outcome table are queried and/or pulled. Distinct reel tables and/or outcome tables included in game processing architecture 300 (FIG. 3) included in EGMs 104 are not queried and/or pulled, as discussed herein.

FIGS. 6A-6D are exemplary user interfaces or screenshots after the triggering and/or activation of metamorphic 424 relating to the double feature, and subsequent playing of bonus games 600A, 600B. More specifically, FIG. 6A is an exemplary user interface or screenshot after metamorphic 424 has been triggered and/or activated and includes a bonus game pick screen 440B. In the exemplary embodiment, metamorphic 424 is triggered and/or activated as a result of the base reel game outcome including enhancement feature symbol 420B in one of the plurality of reels 402-410. As shown in FIG. 6A, the graphic representing metamorphic 424 is changed, adjusted, and/or altered from the previous “buffalo coin” (see, FIGS. 4A-4C) to now depict “DOUBLE.” Such a transformation of metamorphic 424 indicates to the player that bonus games 600A, 600B associated with metamorphic 424 are triggered.

In the exemplary embodiment, the player is provided the option of choosing between two distinct bonus games 600A, 600B. Selectable, first bonus game 600A includes a predetermined number of free plays of a double reel matrix configuration for double feature free spin bonus game 600A (see, FIG. 6B), while selectable second bonus game 600B includes a double feature hold-and-spin bonus game 600B (see, FIGS. 6C and 6D). In exemplary embodiments, the predetermined number of free plays (e.g., no credits required or added by the player) of double feature free spin bonus game 600A is eight (8) free plays. However, it is to be understood that double feature free spin bonus game 600A can include any predetermined number of free plays. As discussed herein, and as a result of triggering metamorphic 424 associated with the double feature, each of double feature free spin bonus game 600A and double feature hold-and-spin bonus game 600B includes unique game play features.

FIG. 6B is an exemplary user interface or screenshot of double feature free spin bonus game 600A. Specifically, FIG. 6B is an exemplary user interface or screenshot after double feature free spin bonus game 600A is initiated from playing base reel game 400, after triggering bonus game pick screen 440B (see, FIG. 6A), and subsequent to the player selecting double feature free spin bonus game 600A, respectively. Double feature free spin bonus game 600A includes a free game indicator 642. Prior to playing double feature free spin bonus game 600A, free game indicator 642 displays and/or presents the predetermined number of free game plays for double feature free spin bonus game 600A. In the exemplary embodiment, the predetermined number of free games is eight “8” free games for double feature free spin bonus game 600A.

Double feature free spin bonus game 600A displayed on display 412 includes a first plurality of reels 602A-610A. Each reel 602A-610A included in double feature free spin bonus game 600A includes the plurality of game symbols 414 including graphic game symbols 416 and/or multiplier symbols 418. In exemplary embodiments, reels 602A-610A included in double feature free spin bonus game 600A include substantially similar game symbols 414 as reels 402-410 of base reel game 400, as discussed herein.

Additionally in the exemplary embodiments, double feature free spin bonus game 600A also includes a distinct or second plurality of reels 602B-610B. That is, and as shown in FIG. 6B, selecting and playing double feature free spin bonus game 600A results in display 412 providing and/or depicting two distinct sets or pluralities of reels 602A-610A, 602B-610B for the player during double feature free spin bonus game 600A. As such, while playing the free games for double feature free spin bonus game 600A, the player is provided two separate sets of reels 602A-610A, 602B-610B to win and/or be awarded credit values via winning symbol combinations and/or paylines, as discussed herein. Similar to the plurality of reels 602A-610A, the distinct or second plurality of reels 602B-610B include the plurality of game symbols 414 including graphic game symbols 416 and/or multiplier symbols 418.

As similarly discussed herein, a single double feature free spin reel table defines each reel of the plurality of reels 602A-610A, 602B-610B used in double feature free spin bonus game 600A, the number of reel stop positions in each reel 602A-610A, 602B-610B, the reel stop position of each of the plurality of graphic game symbols 416/multiplier symbols 418 within each reel 602A-610A, 602B-610B, and the like. In exemplary embodiments, the single, double feature free spin reel table defining the plurality of reels 602A-610A, 602B-610B for double feature free spin bonus game 600A is stored in RNG conversion engine 320 (see, FIG. 3).

Additionally, each outcome for double feature free spin bonus game 600A is determined, defined, and/or identified using a single double feature free spin outcome table that is in communication with and/or utilized in conjunction with the single double feature free spin reel table defining the plurality of reels 602A-610A, 602-610B. In exemplary embodiments, when determining the outcome for double feature free spin bonus game 600A, only the single double feature free spin reel table and single double feature free spin outcome table are queried and/or pulled. Additional reel tables and/or outcome tables included in game processing architecture 300 (FIG. 3) included in EGMs 104 are not queried and/or pulled, as discussed herein.

Referring to FIGS. 6C and 6D, exemplary user interfaces or screenshots of a sequence of double feature hold-and-spin bonus game 600B initiated after playing base reel game 400 (see, FIG. 5A) are displayed. Specifically, FIGS. 6C and 6D are exemplary user interfaces or screenshots after double feature hold-and-spin bonus game 600B is initiated from playing base reel game 400, after triggering bonus game pick screen 440B (see, FIG. 6A), and after the player selects and subsequently plays double feature hold-and-spin bonus game 600B, respectively. In exemplary embodiments, double feature hold-and-spin bonus game 600B includes a plurality of double feature hold-and-spin reels 646 (hereafter, “reels 646”) displaying a plurality of COR symbols 648 (see, FIG. 6D), as well as jackpot symbols 654. Prior to “spinning” the plurality of reels 646, a spin number indicator (not shown) can display and/or present a predetermined number of bonus spins for double feature hold-and-spin bonus game 600B. In exemplary embodiments, the predetermined number of bonus spins for double feature hold-and-spin bonus game 600B is three (3). The user or player of double feature hold-and-spin bonus game 600B “spins” the plurality of reels 646 to attempt to display additional COR symbols 648 and/or jackpot symbols 654 thereon. Each spin in which one or more COR symbol 648 and/or jackpot symbol 654 lands or is displayed on at least one reel 646 of double feature hold-and-spin bonus game 600B resets the spin number indicator back to the predetermined number of spins for double feature hold-and-spin bonus game 600B. In another non-limiting example, the number of bonus spins are not reset in response to displaying COR symbols 548/jackpot symbol 654 during double feature hold-and-spin bonus game 600B. Rather, the player can spin double feature hold-and-spin bonus game 600B the predetermined number of spins (e.g., three spins), before double feature hold-and-spin bonus game 600B ends.

FIG. 6C is an exemplary user interface or screenshot of an outcome of double feature hold-and-spin bonus game 600B. That is, FIG. 6C is an exemplary embodiment after the player has spun the plurality of reels 646 of double feature hold-and-spin bonus game 600B at least once to display a plurality of jackpot symbols 654 thereon.

Additionally, as shown in the exemplary embodiment, the plurality of reels 646 of double feature hold-and-spin bonus game 600B include double feature bonus symbol 656. That is, after spinning the plurality of reels 646, double feature bonus symbol 656 may be displayed, depicted, and/or included in reels 646 and/or in the outcome of double feature hold-and-spin bonus game 600B. As a result of double feature bonus symbol 656 being depicted in reels 646 during double feature hold-and-spin bonus game 600B, all credit values associated with previously depicted COR symbols 648 and/or jackpot symbols 654 are doubled. In exemplary embodiments shown in FIG. 6C, all jackpot symbols 654 included in reels 646 are doubled and/or include an “×2” graphic as a result of reels 646 displaying double feature bonus symbol 656. Although discussed herein as doubling the credit values associated with COR symbols 648 and/or jackpot symbols 654, it is to be understood that displaying double feature bonus symbol 656 in the outcome of double feature hold-and-spin bonus game 600B can result in multiplying all previously displayed credits for COR symbols 648 and/or jackpot symbols 654 by any predetermined factor (e.g., ×2, ×3, ×5, ×10).

Additionally, or alternatively, at least a portion of COR symbols 648, jackpot symbols 654, and/or double feature bonus symbol 656 displayed in double feature hold-and-spin bonus game 600B are pre-populated. For example, a predetermined or random number of spaces included in the plurality of reels 646 in double feature hold-and-spin bonus game 600B are pre-populated prior to performing the first spin. In exemplary embodiments, the position of pre-populated COR symbols 648, jackpot symbols 654, and/or double feature bonus symbol 656 within reels 646 are random, or alternatively correspond to specific game symbols 414 displayed in the base reel game outcome.

FIG. 6D is an exemplary embodiment after the player has spun the plurality of reels 646 of double feature hold-and-spin bonus game 600B, subsequent to the outcome shown in FIG. 6C. In the exemplary embodiment, additional jackpot symbols 654 and COR symbols 648 are displayed in reels 646. Additionally, as shown, a distinct double feature bonus symbol 656B, displaying an “2×” graphic, is depicted in the outcome for double feature hold-and-spin bonus game 600B. It is understood that at least a portion of the credit values associated with previously depicted jackpot symbols 654 and/or COR symbols 648 displayed prior to distinct double feature bonus symbol 656B are multiplied and/or doubled. For example, and as shown in FIG. 6D, at least a portion of jackpot symbols 654 included in reels 646 are doubled again and/or subsequently include an “×4” graphic as a result of reels 646 displaying distinct double feature bonus symbol 656B after displaying and/or spinning distinct jackpot symbols 654, as well as previously displaying double feature bonus symbol 656. Additionally, double feature bonus symbol 656 subsequently is doubled and/or includes an “×2” graphic as a result of reels 646 displaying distinct double feature bonus symbol 656B after displaying and/or spinning double feature bonus symbol 656.

At the end of double feature hold-and-spin bonus game 600B, the credit values corresponding to and/or included with COR symbols 648, jackpot symbols 654, and/or double feature bonus symbol 656, 656B displayed in reels 646 are added to win meter 431.

A single double feature hold-and-spin reel table defines each reel of the plurality of double feature hold-and-spin reels 646 used in double feature hold-and-spin bonus game 600B, the number of reel stop positions in each reel 646, the reel stop position of each of the plurality of COR symbols 648/jackpot symbols 654/double feature bonus symbol 656 within each reel 646, and the like. In exemplary embodiments, the single, double feature hold-and-spin reel table defining the plurality of reels 646 for double feature hold-and-spin bonus game 600B is stored in RNG conversion engine 320 (see, FIG. 3).

Additionally, each outcome for double feature hold-and-spin bonus game 600B is determined, defined, and/or identified using a single double feature hold-and-spin outcome table that is in communication with and/or utilized in conjunction with the single double feature hold-and-spin reel table defining the plurality of reels 646. In exemplary embodiments, when determining the outcome for double feature hold-and-spin bonus game 600B, only the single double feature hold-and-spin reel table and single double feature hold-and-spin outcome table are queried and/or pulled. Additional reel tables and/or outcome tables included in game processing architecture 300 (FIG. 3) included in EGMs 104 are not queried and/or pulled, as discussed herein.

FIGS. 7A-7H are exemplary user interfaces or screenshots after the triggering and/or activation of metamorphic 426 relating to a bounty feature, and subsequent playing of bonus games 700A, 700B. More specifically, FIG. 7A is an exemplary user interface or screenshot after metamorphic 426 has been triggered and/or activated and includes a bonus game pick screen 440C. In the exemplary embodiment, metamorphic 426 is triggered and/or activated as a result of the base reel game outcome including enhancement feature symbol 420C (see, FIG. 4B) in one of the plurality of reels 402-410. As shown in FIG. 7A, the graphic representing metamorphic 426 is changed, adjusted, and/or altered from the previous “buffalo coin” (see, FIGS. 4A-4C) to now depict “BOUNTY.” Such a transformation of metamorphic 426 indicates to the player that bonus games 700A, 700B associated with metamorphic 426 are triggered.

In the exemplary embodiment, the player is provided the option of choosing between two distinct bonus games 700A, 700B. Selectable, first bonus game 700A includes a predetermined number of free plays of a bounty feature free spin game 700A (see, FIGS. 7B-7D), while selectable second bonus game 700B includes a bounty feature hold-and-spin game 700B (see, FIGS. 7E-7H). In exemplary embodiments, the predetermined number of free plays (e.g., no credits required or added by the player) of bounty feature free spin bonus game 700A is eight (8) free plays. However, it is to be understood that bounty feature free spin bonus game 700A can include any predetermined number of free plays. As discussed herein, and as a result of triggering metamorphic 426 associated with the bounty feature, each of bounty feature free spin bonus game 700A and bounty feature hold-and-spin bonus game 700B includes unique game play features.

FIGS. 7B-7D are exemplary user interfaces or screenshots of a sequence of bounty feature free spin bonus game 700A initiated after playing base reel game 400 (see, FIG. 7B). Specifically, FIG. 7B is an exemplary user interface or screenshot after bounty feature free spin bonus game 700A is initiated from playing base reel game 400, after triggering bonus game pick screen 440C (see, FIG. 7A), and subsequent to the player selecting and playing bounty feature free spin bonus game 700A. Bounty feature free spin bonus game 700A includes a free game indicator 742. Prior to playing bounty feature free spin bonus game 700A, free game indicator 742 displays and/or presents the predetermined number of free game plays for bounty feature free spin bonus game 700A. In the exemplary embodiment, the predetermined number of free games is eight “8” free games for bounty feature free spin bonus game 700A (see, FIG. 7A). However, and as shown in FIG. 7B, display 412 depicts the third outcome for bounty feature free spin bonus game 700A, as the player has already spun reels 702-710 and/or played bounty feature free spin bonus game 700A three times. As a result, free game indicator 742 depicts or shows “3 of 8” for the number of free game plays of bounty feature free spin bonus game 700A.

Bounty feature free spin bonus game 700A displayed on display 412 includes the plurality of bounty feature free spin reels 702-710 (hereafter, “reels 702-710”). Each reel 702-710 included in bounty feature free spin bonus game 700A includes the plurality of game symbols 414 including graphic game symbols 416 and/or multiplier symbols 418 (not shown). In exemplary embodiments, reels 702-710 included in bounty feature free spin bonus game 700A include substantially similar game symbols 414. Alternatively, reels 702-710 included in bounty feature free spin bonus game 700A include distinct game symbols 414.

In the exemplary embodiment, and as a result of triggering metamorphic 426 relating to the bounty feature, the plurality of game symbols 414 included in reels 702-710 of bounty feature free spin bonus game 700A can also include at least one upgrade bonus symbol 758. Upgrade bonus symbol 758, when displayed in the outcome of any of the free game plays of bounty feature free spin bonus game 700A, can transform distinct game symbols 414 within reels 702-710. For example, and as shown in FIG. 7C, the outcome of bounty feature free spin bonus game 700A includes game symbols 414 including at least one upgrade bonus symbol 758 and a plurality of distinct, themed (e.g., animal) graphic symbols 760A-760D (e.g., buffalo, wolf, elk, mountain lion). Graphic symbol 760A of the plurality of game symbols 414 includes a substantially similar graphic or design as at least one upgrade bonus symbol 758 (e.g., buffalo). As such, the graphic or visual representation of graphic symbol 760A remains unchanged during bounty feature free spin bonus game 700A when upgrade bonus symbol 758 is included in the outcome. However, graphic symbols 760B, 760C, 760D including distinct graphics (e.g., distinct animals) from the graphics of upgrade bonus symbol 758 are transformed to match the graphic of at least one upgrade bonus symbol 758, as shown in FIG. 7D. Transforming the graphics for each of the graphic symbols 760B, 760C, 760D to match the graphic of upgrade bonus symbol 758 and/or graphic symbols 760A, can increase the credit value awarded to the player during bounty feature free spin bonus game 700A, increase the chances of winning, and/or increase the likelihood of successful paylines for reels 402-410 during bounty feature free spin bonus game 700A.

A single bounty feature free spin reel table defines each reel of the plurality of bounty feature free spin reels 702-710 used in bounty feature free spin bonus game 700A, the number of reel stop positions in each reel 702-710, the reel stop position of each of the plurality of graphic game symbols 416/upgrade bonus symbol 758/graphic symbol 760 within each reel 702-710, and the like. In exemplary embodiments, the single bounty feature free spin reel table defining the plurality of reels 702-710 for bounty feature free spin bonus game 700A is stored in RNG conversion engine 320 (see, FIG. 3).

Additionally, each outcome for bounty feature free spin bonus game 700A is determined, defined, and/or identified using a single bounty feature free spin outcome table that is in communication with and/or utilized in conjunction with the single bounty feature free spin reel table defining the plurality of reels 702-710. In exemplary embodiments, when determining the outcome for bounty feature free spin bonus game 700A, only the single bounty feature free spin reel table and single bounty feature free spin outcome table are queried and/or pulled. Additional reel tables and/or outcome tables included in game processing architecture 300 (FIG. 3) included in EGMs 104 are not queried and/or pulled, as discussed herein.

FIGS. 7E-7H are exemplary user interfaces or screenshots of a sequence of bounty feature hold-and-spin bonus game 700B initiated after playing base reel game 400. Specifically, FIGS. 7E-7H are exemplary user interfaces or screenshots after bounty feature hold-and-spin bonus game 700B is initiated from playing base reel game 400, after triggering bonus game pick screen 440C (see, FIG. 7A), and after the player selects and subsequently plays bounty feature hold-and-spin bonus game 700B, respectively. In exemplary embodiments, bounty feature hold-and-spin bonus game 700B includes a plurality of bounty feature hold-and-spin reels 746 (hereafter, “reels 746”) displaying a plurality of COR symbols 748. Prior to “spinning” the plurality of reels 746, a spin number indicator (not shown) can display and/or present a predetermined number of bonus spins for bounty feature hold-and-spin bonus game 700B. In exemplary embodiments, the predetermined number of bonus spins for bounty feature hold-and-spin bonus game 700B is three (3). The user or player of bounty feature hold-and-spin bonus game 700B “spins” the plurality of reels 746 to attempt to display additional COR symbols 748 thereon. Each spin in which one or more COR symbol 748 lands or is displayed on at least one reel 746 of bounty feature hold-and-spin bonus game 700B resets the spin number indicator back to the predetermined number of spins. In another non-limiting example, the number of bonus spins are not reset in response to displaying COR symbols 748 during bounty feature hold-and-spin bonus game 700B.

FIG. 7E is an exemplary user interface or screenshot of an outcome of bounty feature hold-and-spin bonus game 700B. That is, FIG. 7E is an exemplary embodiment after the player has spun the plurality of reels 746 of bounty feature hold-and-spin bonus game 700B at least once to display a plurality of COR symbols 748 thereon.

Additionally, as shown in the exemplary embodiment, the plurality of reels 746 of bounty feature hold-and-spin bonus game 700B include at least one award-all bonus symbol 762. That is, after spinning the plurality of reels 746, award-all bonus symbol 762 is displayed, depicted, and/or included in reels 746 and/or in the outcome of bounty feature hold-and-spin bonus game 700B. As a result of award-all bonus symbol 762 being depicted in reels 746, a total credit value for all credit values included in COR symbols 748 displayed during bounty feature hold-and-spin bonus game 700A prior to displaying award-all bonus symbol 762 are awarded to and/or associated with award-all bonus symbol 762. That is, after award-all bonus symbol 762 is displayed in the outcome of bounty feature hold-and-spin bonus game 700B, all credit values associated with COR symbols 748 previously displayed in reels 746 are added or totaled. The total of all credit values for previously displayed COR symbols 748 is then associated with the displayed award-all bonus symbol 762. FIGS. 7F-7H are exemplary user interfaces or screenshots of a sequence of depicting the credit values for all previously displayed COR symbols 748 as they are progressively added to the credit value to be associated with award-all bonus symbol 762. As a result, and as shown in FIG. 7H, the credit value for award-all bonus symbol 762 is equal to “2800.”

Additionally, or alternatively, at least a portion of COR symbols 748 and/or award-all bonus symbol 762 displayed in bounty feature hold-and-spin bonus game 700B are pre-populated. For example, a predetermined or random number of spaces included in the plurality of reels 746 in bounty feature hold-and-spin bonus game 700B are pre-populated prior to performing the first spin in bounty feature hold-and-spin bonus game 700B. In exemplary embodiments, the position of pre-populated COR symbols 748 and/or award-all bonus symbol 762 within reels 746 are random, or alternatively correspond to specific game symbols 414 displayed in the base reel game outcome.

During subsequent spins, if a distinct award-all bonus symbol 762 is displayed in reels 746, the credit value for the distinct award-all bonus symbol 762 will include all credit values associated with previously displayed COR symbols 748, as well as the credit value associated with any previously displayed award-all bonus symbol(s) 762. At the end of bounty feature hold-and-spin bonus game 700B, the credit values corresponding to and/or included with COR symbols 748 and/or award-all bonus symbol 762 displayed in reels 746 are added to win meter 431.

A single bounty feature hold-and-spin reel table defines each reel of the plurality of bounty feature hold-and-spin reels 746 used in bounty feature hold-and-spin bonus game 700B, the number of reel stop positions in each reel 746, the reel stop position of each of the plurality of COR symbols 748/award-all bonus symbol 762 within each reel 746, and the like. In exemplary embodiments, the single, bounty feature hold-and-spin reel table defining the plurality of reels 746 for bounty feature hold-and-spin bonus game 700B is stored in RNG conversion engine 320 (see, FIG. 3).

Additionally, each outcome for bounty feature hold-and-spin bonus game 700B is determined, defined, and/or identified using a single bounty feature hold-and-spin outcome table that is in communication with and/or utilized in conjunction with the single bounty feature hold-and-spin reel table defining the plurality of reels 746. In exemplary embodiments, when determining the outcome for bounty feature hold-and-spin bonus game 700B, only the single bounty feature hold-and-spin reel table and single bounty feature hold-and-spin outcome table are queried and/or pulled. Additional reel tables and/or outcome tables included in game processing architecture 300 (FIG. 3) included in EGMs 104 are not queried and/or pulled, as discussed herein.

Although the implementations shown in FIGS. 5A-7H illustrate bonus games 500A-700B having a single enhancement feature, any of the enhancement features of bonus games 500A-700B can be mixed, matched, and/or combined during gameplay. For example, bonus games 500A-700B can include any combination of the power feature, the double feature, and/or the bounty feature, such that any two or all three of these features can be included in a single bonus game. For example, FIGS. 8A and 8B are exemplary user interfaces or screenshots where metamorphic 422 and metamorphic 426 are both triggered at the same time. As such, and with reference to FIG. 8B, combination free spin bonus game 800A can include both at least one multiplier bonus symbol 544, as well as at least one upgrade bonus symbol 758 in the plurality of combination reels 802-810.

As similarly discussed herein, a single combination free spin reel table defines each reel of the plurality of combination game reels 802-810 used in combination free spin bonus game 800A, the number of reel stop positions in each reel 802-810, the reel stop position of each multiplier bonus symbol 544/upgrade bonus symbol 758/graphic symbol 760 within each reel 802-810, and the like. In exemplary embodiments, the single combination free spin reel table defining the plurality of reels 802-810 for combination free spin bonus game 800A is stored in RNG conversion engine 320 (see, FIG. 3).

Although a single combination game is shown (e.g., combination free spin bonus game 800A) it is understood that each combination of bonus games 500A-700B) includes its own combination free spin reel table for defining the reels used in that combination free spin game. For example, where all three metamorphics 422, 424, 426 are triggered at the same time, the combination free spin bonus game (not shown) can include at least one multiplier bonus symbol 544, as well as at least one upgrade bonus symbol 758 in the plurality of combination double reels, as similarly shown and discussed herein with respect to FIG. 6B (e.g., reels 602A-610A, 602B-610B). In this example, where the combination free spin bonus game triggers all three metamorphics 422, 424, 426 and associated features (e.g., power feature, double feature, bonus feature), a single combination free spin reel table defines each reel of the plurality of combination game reels used in the combination free spin bonus game, the number of reel stop positions in each reel, the reel stop position of each multiplier bonus symbol 544/upgrade bonus symbol 758/graphic symbol 760 within each reel, and the like. The combination free spin reel table for the combination bonus game that triggers all three metamorphics 422, 424, 426 is distinct from the combination free spin reel table for combination free spin game 800A, as discussed herein.

Additionally, each outcome for combination free spin bonus game 800A is determined, defined, and/or identified using a single combination free spin game outcome table that is in communication with and/or utilized in conjunction with the single combination free spin reel table defining the plurality of reels 802-810. In exemplary embodiments, when determining the outcome for combination free spin bonus game 800A, only the single combination free spin reel table and single combination free spin outcome table are queried and/or pulled.

As discussed herein, only a single reel table and/or outcome table included in game processing architecture 300 (FIG. 3) is queried and/or pulled when playing base reel game 400, bonus games 500A-700A, or combination game 800A. That is, during gameplay, when base reel game 400 is being played, only a single base reel game reel table and base reel game outcome table are queried, pulled, and/or relied upon by the system to play the game on EGM 104. If a bonus game 500A-700B, or combination game 800A is triggered as a result of the base reel game outcome for base reel game 400, then the system subsequently identifies and only queries, pulls, and/or relies on the specific reel table and outcome table to play the triggered bonus game 500A-700B or combination game 800A on EGM 104. For example, and in response to triggering power feature free spin bonus game 500A during base reel game 400, the system may query, pull, and/or only rely on the single power feature free spin reel table defining reels 502-510 and single power feature free spin outcome table for power feature free spin bonus game 500A during gameplay on EGM 104. In doing so, EGMs 104, and the processing systems/controller systems included therein, can improve game processing and/or reduce required processing power as a result of each game 400, 500A-700B, 800A relying on distinct, single identifiable reel tables and outcome tables for implementing gameplay.

With respect to combination free spin bonus game 800A, the outcome of each game is awarded in a predefined order. For example, the bonuses, bonus features, and/or bonus awards associated with the power feature and bounty feature included in combination free spin bonus game 800A are awarded only after graphic symbols 760 displayed in the outcome of combination free spin bonus game 800A are transformed as a result of upgrade bonus symbol 758 also being displayed. That is, any multiplier (e.g., multiplier bonus symbol 544) awarded and/or applied the total credit award for the outcome of combination free spin bonus game 800A may only be applied after (1) each graphic symbol 760 displayed in the outcome of combination free spin bonus game 800A is transformed by upgrade bonus symbol 758 included in the outcome of combination free spin bonus game 800A, and (2) a credit award value is determined based on the “upgraded” graphic symbols 760, as similarly discussed herein with respect to FIGS. 7B-7D.

It is to be understood, and as similarly discussed herein with respect to combination free spin bonus game 800A, that each combination hold-and-spin bonus games (not shown) also includes a single reel table and/or outcome table included in game processing architecture 300 (FIG. 3). That is, a single combination hold-and-spin reel table defines each reel of the plurality of combination game reels used in combination hold-and-spin bonus games, the number of reel stop positions in each reel for combination hold-and-spin bonus games, the reel stop position of each power feature bonus symbol 550/double feature bonus symbol 656/award-all bonus symbol 762 displayed within each reel for the combination hold-and-spin bonus games, and the like. Moreover, each outcome for each combination hold-and-spin bonus game is determined, defined, and/or identified using a single combination hold-and-spin game outcome table that is in communication with and/or utilized in conjunction with the single combination hold-and-spin reel table. As discussed herein, the single combination hold-and-spin game outcome table is associated with and/or corresponds to the metamorphics 422, 424, 426 and associated features (e.g., power feature, double feature, bonus feature) that are triggered within the combination hold-and-spin bonus games.

In an exemplary embodiment, the outcome of a combination hold-and-spin bonus game (not shown) is award in a predefined order. For example, bonuses, bonus features, and/or bonus awards associated with the power feature, the double feature, and bounty feature are awarded during the outcome in a combination hold-and-spin bonus game in an order defined by: (1) power feature bonuses/awards, (2) double feature bonuses/award, and (3) bounty feature bonuses/awards. As such, where the combination hold-and-spin bonus game (not shown) includes all three features, and the outcome displays power feature bonus symbol 550, double feature bonus symbol 656, and award-all bonus symbol 762 within the reels (e.g., reels 646), outcome awards and/or winnings are first influenced or affected by power feature bonus symbol 550, then double feature bonus symbol 656, and finally by award-all bonus symbol 762. In another exemplary embodiment, the bonuses, bonus features, and/or bonus awards associated with the power feature, the double feature, and bounty feature are awarded to during the outcome in a combination hold-and-spin bonus game at random.

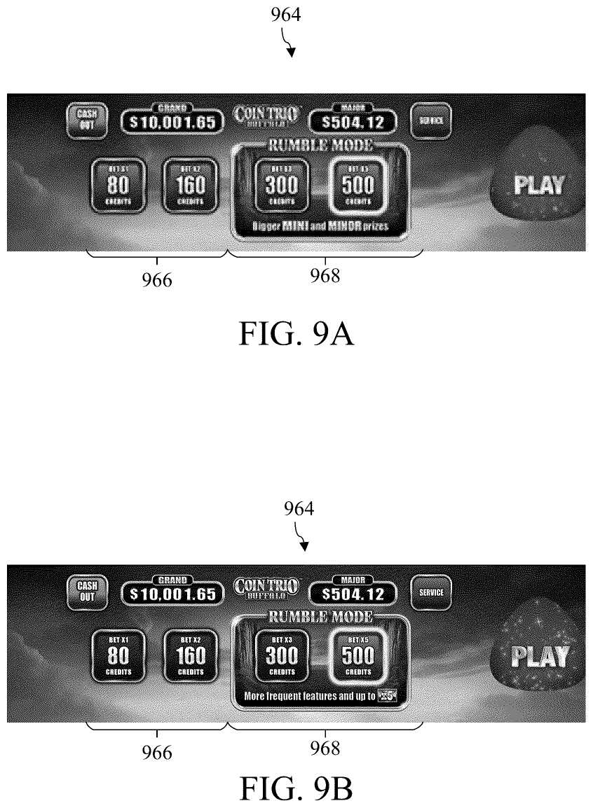

FIGS. 9A and 9B are exemplary user interfaces or screenshots of a wagering screen or wagering options 964. In exemplary embodiments, players can provide “standard” credit amounts 966 (e.g., “80 credits,” “160 credits”), or can provide increased credit amounts (e.g., “300 credits,” “500 credits”)—referred to herein as rumble mode 968. In rumble mode 968, game play of base reel game 400 and/or bonus games 500A-700B are altered and/or adjusted. For example, and as indicated in FIGS. 9A and 9B, rumble mode 968 (e.g., increased betting credit amounts) can increase the credit value for jackpot bonuses 432-438 (see, FIGS. 4A-4C), increase the likelihood of triggering metamorphics 422-426, and/or increase the value of multiplier symbols 418.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the implementations described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc - read only memory (CD-ROM), a magneto-optical disk (MOD), and/or a digital versatile disc (DVD) may also be used. Also, in the implementations described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary implementation, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g., an EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
at least one memory for storing instructions; and
a game controller in communication with the at least one memory, the game controller including at least one processor, wherein when the instructions are executed by the at least one processor, the at least one processor is configured to:
cause to be displayed on a display device a base reel game including a plurality of reels, the plurality of reels including at least one of graphic game symbols, or metamorphic enhancement feature symbols, wherein the plurality of reels are defined by a base game reels table;
determine that a base reel game outcome triggers each metamorphic enhancement feature of a plurality of metamorphic enhancement features associated with the metamorphic enhancement feature symbols, the base reel game outcome determined using a base reel game outcome table;
cause to be displayed on the display device two distinct, selectable bonus games, each of the two distinct, selectable bonus games associated with the triggered, plurality of metamorphic enhancement features, wherein the two distinct, selectable bonus games include (i) a free spin bonus game including a plurality of bonus game reels defined by a bonus game reels table and (ii) a hold-and-spin bonus game including a distinct plurality of bonus game reels defined by a distinct bonus game reels table; and
in response to the free spin bonus game of the two distinct bonus games being selected, cause to be displayed on the display device the plurality of bonus game reels defined by the bonus game reels table for the selected free spin bonus game.

2. The electronic gaming system of claim 1, wherein the plurality of metamorphic enhancement features include:
a power feature;
a double feature; and
a bounty feature.

3. The electronic gaming system of claim 2, wherein the plurality of bonus game reels defined by the bonus game reels table for the selected, free spin bonus game include:
at least one multiplier bonus symbol associated with the power feature; and
at least one upgrade bonus symbol associated with the bounty feature.

4. The electronic gaming system of claim 3, wherein the instructions stored in the memory, when executed by the at least one processor, further cause the at least one processor to:
in response to the at least multiplier bonus symbol being displayed on the display device during the selected free spin bonus game, multiple a credit value awarded during the selected free spin bonus game by a predetermined factor displayed on the at least one multiplier bonus symbol.

5. The electronic gaming system of claim 3, wherein the instructions stored in the memory, when executed by the at least one processor, further cause the at least one processor to:
in response to the at least one upgrade bonus symbol being displayed on the display device during the selected free spin bonus game, transform at least one graphic game symbol included in the plurality of bonus game reels into a distinct graphic game symbol matching the at least one upgrade bonus symbol.

6. The electronic gaming system of claim 3, wherein the plurality of bonus game reels defined by the bonus game reels table for the selected, free spin bonus game include:
a double reel matrix configuration associated with the double feature, wherein the double reel matrix configuration includes a first plurality of bonus game reels, and a second plurality of bonus game reels, the first plurality of bonus game reels and the second plurality of bonus game reels defined by the bonus game reels table.

7. The electronic gaming system of claim 2, wherein the instructions stored in the memory, when executed by the at least one processor, further cause the at least one processor to:
in response to the hold-and-spin bonus game of the two distinct bonus games being selected, cause to be displayed on the display device the distinct plurality of bonus game reels defined by the distinct bonus game reels table for the selected hold-and-spin bonus game, the distinct plurality of bonus game reels including:
at least one power feature bonus symbol associated with the power feature, the at least one power feature bonus symbol including a randomly generated credit value;
at least one double feature bonus symbol associated with the double feature, wherein the at least one double feature bonus symbol multiplies at least one of a credit values included within at least one cash-on-reel (COR) symbol and a jackpot credit value included within at least one jackpot symbol displayed during the hold-and-spin bonus game prior to displaying the at least one double feature bonus symbol; and
at least one award-all bonus symbol associated with the bounty feature, the at least one award-all bonus symbol includes a total credit value of all credit values included within the at least one COR symbol displayed during the hold-and-spin bonus game prior to displaying the at least one award-all bonus symbol.

8. A method of electronic gaming implemented on an electronic gaming machine, the method comprising:
causing to be displayed on a display device a base reel game including a plurality of reels, the plurality of reels including at least one of graphic game symbols, or metamorphic enhancement feature symbols, wherein the plurality of reels are defined by a base game reels table;
determining that a base reel game outcome triggers each metamorphic enhancement feature of a plurality of metamorphic enhancement features associated with the metamorphic enhancement feature symbols, the base reel game outcome determined using a base reel game outcome table;
causing to be displayed on the display device two distinct, selectable bonus games, each of the two distinct, selectable bonus games associated with the triggered, plurality of metamorphic enhancement features, wherein the two distinct, selectable bonus games include (i) a free spin bonus game including a plurality of bonus game reels defined by a bonus game reels table and (ii) a hold-and-spin bonus game including a distinct plurality of bonus game reels defined by a distinct bonus game reels table; and
in response to the free spin bonus game of the two distinct bonus games being selected, causing to be displayed on the display device the plurality of bonus game reels defined by the bonus game reels table for the selected free spin bonus game.

9. The method of claim 8, wherein the plurality of metamorphic enhancement features include:
a power feature;
a double feature; and
a bounty feature.

10. The method of claim 9, wherein the plurality of bonus game reels defined by the bonus game reels table for the selected, free spin bonus game include:
at least one multiplier bonus symbol associated with the power feature; and
at least one upgrade bonus symbol associated with the bounty feature.

11. The method of claim 10, further comprising:
in response to the at least multiplier bonus symbol being displayed on the display device during the selected free spin bonus game, multiplying a credit value awarded during the selected free spin bonus game by a predetermined factor displayed on the at least one multiplier bonus symbol.

12. The method of claim 10, further comprising:
in response to the at least one upgrade bonus symbol being displayed on the display device during the selected free spin bonus game, transforming at least one graphic game symbol included in the plurality of bonus game reels into a distinct graphic game symbol matching the at least one upgrade bonus symbol.

13. The method of claim 10, wherein the plurality of bonus game reels defined by the bonus game reels table for the selected, free spin bonus game include:
a double reel matrix configuration associated with the double feature, wherein the double reel matrix configuration includes a first plurality of bonus game reels, and a second plurality of bonus game reels, the first plurality of bonus game reels and the second plurality of bonus game reels defined by the bonus game reels table.

14. The method of claim 13, further comprising:
in response to the hold-and-spin bonus game of the two distinct bonus games being selected, causing to be displayed on the display device the distinct plurality of bonus game reels defined by the distinct bonus game reels table for the selected hold-and-spin bonus game, the distinct plurality of bonus game reels including:
at least one power feature bonus symbol associated with the power feature, the at least one power feature bonus symbol including a randomly generated credit value;
at least one double feature bonus symbol associated with the double feature, wherein the at least one double feature bonus symbol multiplies at least one of a credit values included within at least one cash-on-reel (COR) symbol and a jackpot credit value included within at least one jackpot symbol displayed during the hold-and-spin bonus game prior to displaying the at least one double feature bonus symbol; and
at least one award-all bonus symbol associated with the bounty feature, the at least one award-all bonus symbol includes a total credit value of all credit values included within the at least one COR symbol displayed during the hold-and-spin bonus game prior to displaying the at least one award-all bonus symbol.

15. A non-transitory computer-readable storage medium with instructions stored thereon that, in response to execution by at least one processor, cause the at least one processor to:
cause to be displayed on a display device a base reel game including a plurality of reels, the plurality of reels including at least one of graphic game symbols, or metamorphic enhancement feature symbols, wherein the plurality of reels are defined by a base game reels table;
determine that a base reel game outcome triggers each metamorphic enhancement feature of a plurality of metamorphic enhancement features associated with the metamorphic enhancement feature symbols, the base reel game outcome determined using a base reel game outcome table;
cause to be displayed on the display device two distinct, selectable bonus games, each of the two distinct, selectable bonus games associated with the triggered, plurality of metamorphic enhancement features, wherein the two distinct, selectable bonus games include (i) a free spin bonus game including a plurality of bonus game reels defined by a bonus game reels table and (ii) a hold-and-spin bonus game including a distinct plurality of bonus game reels defined by a distinct bonus game reels table; and
in response to the free spin bonus game of the two distinct bonus games being selected, cause to be displayed on the display device the plurality of bonus game reels defined by the bonus game reels table for the selected free spin bonus game.

16. The non-transitory computer-readable storage medium of claim 15, wherein the plurality of metamorphic enhancement features include:
a power feature;
a double feature; and
a bounty feature.

17. The non-transitory computer-readable storage medium of claim 16, wherein the plurality of bonus game reels defined by the bonus game reels table for the selected, free spin bonus game include:
at least one multiplier bonus symbol associated with the power feature; and
at least one upgrade bonus symbol associated with the bounty feature.

18. The non-transitory computer-readable storage medium of claim 17, wherein the at least one processor is further configured to:
in response to the at least multiplier bonus symbol being displayed on the display device during the selected free spin bonus game, multiple a credit value awarded during the selected free spin bonus game by a predetermined factor displayed on the at least one multiplier bonus symbol.

19. The non-transitory computer-readable storage medium of claim 17, wherein the at least one processor is further configured to:
in response to the at least one upgrade bonus symbol being displayed on the display device during the selected free spin bonus game, transform at least one graphic game symbol included in the plurality of bonus game reels into a distinct graphic game symbol matching the at least one upgrade bonus symbol.

20. The non-transitory computer-readable storage medium of claim 17, wherein the plurality of bonus game reels defined by the bonus game reels table for the selected, free spin bonus game include:
a double reel matrix configuration associated with the double feature, wherein the double reel matrix configuration includes a first plurality of bonus game reels, and a second plurality of bonus game reels, the first plurality of bonus game reels and the second plurality of bonus game reels defined by the bonus game reels table.
